(19) United States
(12) Patent Application Publication
(10) Pub. No.: US 2018/0268508 A1
(43) Pub. Date: Sep. 20, 2018

(54) METHODS AND SYSTEMS TO SCREEN ONE OR MORE INDIVIDUALS AT A NON-LAW ENFORCEMENT FACILITY

(71) Applicant: IDENT SOLUTIONS, LLC, Logan, UT (US)

(72) Inventors: Daniel Vincent Spillman, Kaysville, UT (US); Bret D. Wardle, Murray, UT (US); Jace Alan Ruppe, Kaysville, UT (US); Gregory Louis Turner, Layton, UT (US)

(21) Appl. No.: 15/920,120

(22) Filed: Mar. 13, 2018

Related U.S. Application Data
(60) Provisional application No. 62/470,978, filed on Mar. 14, 2017.

(51) Int. Cl. G06Q 50/26; G06F 17/30

(52) U.S. Cl. CPC G06Q 50/26; H04W 88/08; G06F 17/30477; G06Q 50/265

(57) ABSTRACT

An example method to screen one or more individuals at a non-law enforcement facility includes generating a first request at an access point. The first request includes one or more identifying information for the one or more individuals. The access point is associated with, located at, and/or located near the non-law enforcement facility. The access point includes a first communication transceiver. The method also includes, with the first communication transceiver, transmitting the first request to at least one communication server that is not under law enforcement only control. The method also includes, with the first communication transceiver, receiving at least a portion of a local result of a search of at least one local database.

### CROSS-REFERENCE TO RELATED APPLICATIONS

This application claims priority to U.S. Provisional Application No. 62/470,978 filed on Mar. 14, 2017, the disclosure of which is incorporated herein, in its entirety, by this reference.

### BACKGROUND

Certain locations may require one or more individuals to be screened prior to entering the location. However, many of these locations do not have direct access to government databases that can be used to screen the individuals. These locations may require the individuals to enter identifying information into logs. These locations can request local law enforcement agencies to check the government databases on their behalf. However, such requests can be time consuming and overburden government resources.

As such, locations that require individuals to be screened prior to entering the location and/or groups (e.g., local law enforcement agencies) that perform screening services continue to seek new ways to screen individuals.

### SUMMARY

Embodiments disclosed herein are directed to methods and systems to screen one or more individuals at a non-law enforcement facility and related systems. In an embodiment, a method generating a first request at an access point. The first request includes one or more identifying information for the one or more individuals. The access point located at and/or near the non-law enforcement facility. The access point including memory storage medium including one or more instructions stored therein, at least one processor configured to execute the one or more instructions, one or more input devices configured to receive the one or more identifying information, a display, and a first communication transceiver coupled to the processor. The method also includes, with the first communication transceiver, transmitting the first request to at least one communication server that is not under law enforcement only control. The method also includes, with the first communication transceiver, receiving at least a portion of a local result of a search of at least one local database that is not under law enforcement only control.

In an embodiment, a method to screen one or more individuals at a non-law enforcement facility is disclosed. The method includes receiving a first request from an access point at a communication server that is not under law enforcement only control. The first request includes one or more identifying information of the one or more individuals. The communication server includes a central processing unit and a second communication transceiver. The second communication transceiver is communicably coupled to the access point. The method also includes, with the second communication transceiver, transmitting at least the one or more identifying information of the one or more individuals to at least one government database. Finally, the method includes, with the second communication transceiver, receiving a government result of a search of the at least one government database. The government result including identifying information stored on the at least one government database that at least partially matched the one or more identifying information of the one or more individuals and information associated with the identifying information stored on the at least one government database.

In an embodiment, a system to screen one or more individuals from a non-law enforcement facility is disclosed. The system includes an access point at and/or near the non-law enforcement facility. The access point includes memory storage medium including one or more instructions stored therein, at least one processor configured to execute the one or more instructions, one or more input devices configured to receive the one or more identifying information, a display, and a first communication transceiver coupled to the processor. The system also includes a communication server that is not under law enforcement only control. The communication server including a central processing unit and a second communication transceiver coupled to the first communication transceiver. Finally, the system includes at least one local database operably coupled to at least one of the access point and/or the communication server. The at least one local database stored on memory storage medium of a general purpose or special purpose computer. The at least one local database is configured to be searched to find matches between the plurality of government results stored thereon and the one or more identifying information received by the at least one local database. Each of the government results includes identifying information used to generate the government result and information associated with the identifying information used to generate the government result that was found during a previous search of at least one government database.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic view of a system that is used to one or more screen individuals, according to an embodiment.

FIG. 2 is a flow chart of a method to screen one or more individuals using the system of FIG. 1, according to an embodiment, from the perspective of the access point.

FIG. 3 is a flow chart of a method to screen one or more individuals the system of FIG. 1, according to an embodiment, from the perspective of the access point. For ease of illustration, FIG. 3 has been split into FIGS. 3A, 3B, and 3C.

FIG. 4 is a flow chart of a method to screen one or more individuals using the system of FIG. 1, according to an embodiment, from the perspective of the communication server.

FIG. 5 is a flow chart of a method to screen individuals using the system of FIG. 1, according to an embodiment, from the perspective of the communication server. For ease of illustration, FIG. 5 has been split into FIGS. 5A, 5B, and 5C.

FIG. 6 is a flow chart of a method to screen one or more individuals using the system of FIG. 1, according to an embodiment, from the perspective of the local database.

FIG. 7 is a flow chart of a method to screen one or more individuals using the system of FIG. 1, according to an embodiment, from the perspective of the government database.

FIG. 8 is a flow chart of a method to screen one or more individuals using the system of FIG. 1, according to an embodiment, from the perspective of the law enforcement agency.

FIG. 9 is a schematic view of a system that is used to screen one or more individuals, according to an embodiment.

FIG. 10 is a flow chart of a method to screen one or more individuals using the system of FIG. 9, according to an embodiment, from the perspective of the local law enforcement agency server. For ease of illustration, FIG. 10 has been split into FIGS. 10A and 10B.

### DETAILED DESCRIPTION

Embodiments disclosed herein are directed to methods and systems to screen one or more individuals at a non-law enforcement facility (e.g., school, critical infrastructure facility, a government or non-government research facility, manufacturing facility, hotel, etc.) and related systems. In an embodiment, a method includes generating a first request at an access point. The first request includes one or more identifying information for the one or more individuals (e.g., visitors). The access point is associated with, located at, and/or located near the non-law enforcement facility. The access point includes memory storage medium including one or more instructions stored therein, at least one processor configured to execute the one or more instructions, one or more input devices configured to receive the one or more identifying information, a display, and a first communication transceiver coupled to the processor. The method also includes, with the first communication transceiver, transmitting the first request to at least one communication server that is not under law enforcement only control. The method also includes, with the first communication transceiver, receiving at least a portion of a local result of a search of at least one local database. As used herein, “at least a portion of the local result” includes one or more of the entirety of the actual local result, a portion of the local government result, or information derived from at least a portion of the actual local result.

In an embodiment, the method can further include comparing the identifying information of the first request against information stored on at least one government database. For example, the method can include transmitting the identifying information from the communication server to the government database that is within direct governmental control and searching the government database using the identifying information. The government result of the search of the government database can be received by the communication server. The communication server can then transmit at least a portion of the government result to the access point. As used herein, “at least a portion of the government result” includes at least one the entirety of the actual government result, a portion of the actual government result, or information derived from at least a portion of the actual government result (e.g., a “pending,” “cleared,” or “not cleared” message, as will be discussed in more detail below). In an embodiment, at least a portion of the government result can be stored on the local database.

The methods and systems disclosed herein are used to screen (e.g., restrict or grant access) individuals as or before they attempt to enter one or more non-law enforcement facilities. For example, the non-law enforcement facility can be a school and the methods and systems disclosed herein are used to restrict access to individuals who pose a risk to the school (e.g., convicted sex offenders, wanted persons, etc.). In another example, the non-law enforcement facility can be a manufacturing facility and the methods and systems disclose herein are used to restrict access to individuals who pose a risk to the facility (e.g., wanted persons, known violent offenders, etc.). In another example, the location can be a non-law enforcement government facility and the methods and systems disclose herein are used to restrict access to individuals who pose a risk to the facility (e.g., suspected terrorists, etc.). As used herein, a non-law enforcement facility does not include police departments, sheriff's offices, law enforcement and public safety communications centers, fire departments, private security agencies, and governmental authorities (e.g., governmental authorities other than critical infrastructure facilities such as power generation plants, schools, etc.).

In an embodiment, the methods and systems disclosed herein allow partners (to indirectly access government database through sponsors. A “partner,” as used herein, refers to individuals, business, government agencies, or other entities that, typically, do not have direct access to at least one government database. In an example, the “partner” can include an individual located in, a manager of, an business owner of, a property owner of, or any other interested party of the non-law enforcement facility. In an example, the “partner” can include a third party, that is, a non-law enforcement entity. A “sponsor,” as used herein, refers to individuals, government agencies, business, or other entities that, typically, have access to at least one government database and can provide access to the at least one government database to the partner. Examples of a “sponsor” include local or state police, the Federal Bureau of Investigation, or other local, state, or federal law enforcement agencies. As such, a partner can enable a sponsor to use the methods and systems disclosed herein to access a government database using the access point at the non-law enforcement facility. In an embodiment, a partner is required to have at least one sponsor to access the government database.

The methods and systems disclose herein amount to significant improvements in the computer-rooted field of performing searches of a government database by a partner. For example, the methods and systems disclosed herein allow the partner to screen individuals using government databases without violating applicable statutes, codes, or administrative procedures. Additionally, the methods and systems disclosed herein allow non-law enforcement facility (e.g., an person at or near the non-law enforcement facility) to screen individuals quickly and without overburdening government resources. For instance, the local database search can be used to screen an individual without using government resources. Further, the government databases can be accessed without requiring assistance from law enforcement personnel. Additionally, in some embodiments, a “cleared” message can be provided to the access point without the assistance of law enforcement personnel. In another example, the methods and systems disclosed herein result in a continuously learning system because the local database can store at least a portion of the results of previous searches of the government databases. As such, the local database can provide information regarding the individual without needing to access or search the government databases.

The devices disclosed herein (e.g., the access point, the communication server, the local database, the government database, etc.) can include general purpose or special purpose computing systems, environments, or configurations. Examples of general purpose or special purpose computing system environments or configurations that can be used include personal computers, laptop computers, server computers, mobile phones and/or other mobile devices (e.g., tablets), minicomputers, microprocessor systems, multiprocessor systems, mainframe computers, programmable consumer electronics, networked computers, distributed computing environments (e.g., remote processing devices that are linked via a network) that include any of the above devices, or any other similar devices. In a distributed computing environment, program modules may be located in both local and remote computers.

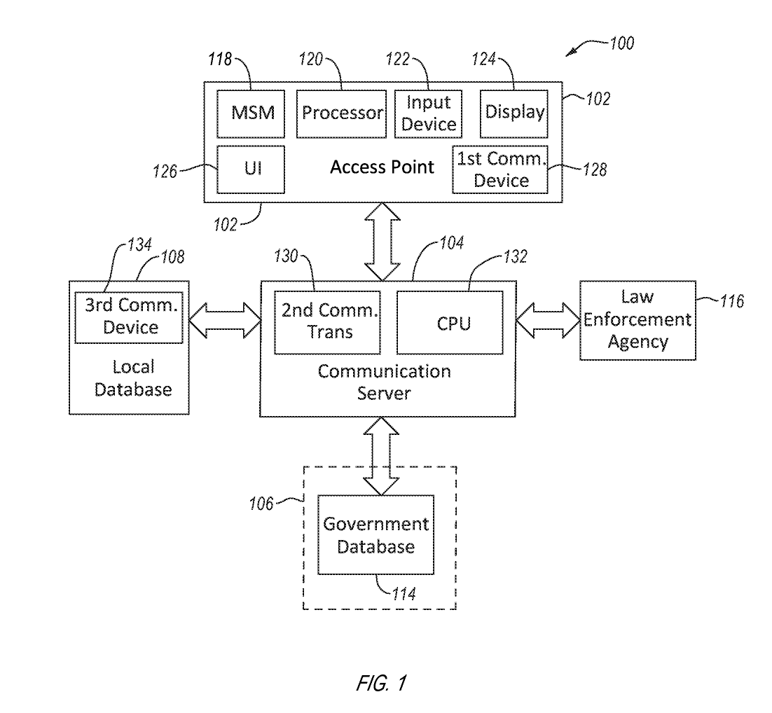

FIG. 1 is a schematic view of a system 100 that is used to one or more screen individuals, according to an embodiment. The system 100 includes an access point 102 that is at and/or near the non-law enforcement facility. The access point 102 is configured to receive identifying information of the one or more individuals that are being screened. The access point 102 is coupled to and configured to transmit the identifying information to at least one communication server 104. In the illustrated embodiment, the communication server 104 is coupled to and configured to transmit information between the access point 102, the at least one local database 108, the at least one government database 114, and/or other entities (e.g., law enforcement agency 116). In an embodiment, the communication server 104 transfers the identifying information to the local database 108 and the local database 108 is searched. The communication server 104 can transmit the at least a portion of a local result of the search of the local database 108 to the access point 102. In an embodiment, the communication server 104 transmits the identifying information to the government database 114. The government database 114 can include at least one of Criminal Justice Information Services (“CJIS”) databases, the National Crime Information Center (“NCIC”) databases, other federal criminal databases, at least one municipal or state criminal database, or other municipal, state, or federal databases that have restricted access. The government database 114 can be searched to determine if there are any at least partial matches between the identifying information and the information stored therein. The government result of the search can be transmitted to the communication server 104. The communication server 104 parses (e.g., analyzes) the government result to determine if the information contained in the government report is or is not associated with one or more entrance criteria. The entrance criteria can be pre-defined by the sponsor and/or the partner and identifying information that matches at least one of the entrance criteria can indicate that the individual should not be emitted into the non-law enforcement facility. In an embodiment, the communication server 104 determines that the government result is not associated with the entrance criteria. In such an embodiment, the communication server 104 transmits a message a “cleared” message (e.g., any suitable message indicating that the government result is not associated with an entrance criteria) to the access point 102. In an embodiment, the second server 104 determines that the government result is associated with the entrance criteria or if the communication server 104 is unsure if the government result is associated with the entrance criteria. In such an embodiment, according to current government restrictions, the communication server 104 transmits at least a portion of (e.g., all of) the government result to an law enforcement agency 116 and the communication server 104 can transmit a “pending” message (e.g., any suitable message indicating that the government results is being reviewed by the law enforcement agency 116) to the access point 102. The law enforcement agency 116 can parse the government result received thereby to determine if the government result is or is not associated with the entrance criteria and transmit a “cleared” message or “not cleared” message (e.g., any suitable message indicating that the government result is associated with the entrance criteria) to the communication server 104 responsive to their review. The communication server 104 can then transmit a “cleared” or “not cleared” message to the access point 102. The communication server 104 can save at least some of the information generated during the method in the local database 108.

The access point 102 is configured to receive information from an individual (e.g., visitor to the non-law enforcement facility) and convey the information to the communication server 104. As such, the access point 102 can include memory storage medium (“MSM”) 118, at least one processor 120, and one or more input devices 122. The MSM 118 includes one or more instructions (e.g., computer readable instructions, data structures, program modules, and other data for use in a computer) stored therein. The instructions can include programs that, when executed by the processor 120, are used to at least one of generate a first request directing the communication server 104 to transmit at least the identifying information to at least the local database 108, generate a second request directing the communication server 104 to transmit at least the identifying information to the government database 114, etc. The MSM 118 can also store information thereon (e.g., the identifying information). The input devices 122 allow a person using the access point 102 (e.g., a person at or near the non-law enforcement facility) to input the identifying information into the access point 102. For example, the inputs 122 can include a mouse, keyboard, a touch screen, etc. In another example, the inputs 122 can include a scanner, a camera, or other image capturing device that is configured to image a document that includes the identifying information thereon (e.g., a driver's license, a birth certificate, a passport, a visa, etc.). In such an example, the MSM 118 can include recognition software that, when executed by the processor 120, can extract the relevant information from the captured image. In an example, the access point 102 can include at least one of a computer terminal, a mobile device, a web socket connection, web application, a mobile application, or another suitable device or suitable software.

The access point 102 can include a display 124 that is configured to convey information to the person using the access point 102. The access point 102 can also include a user interface 126 that conveys information through the display 124 and allows the person using the access point 102 to interact with the access point 102. For example, the user interface 126 can convey what identifying information has been inputted, the result of the search of the local or government database 114, etc.

In an embodiment, the access point 102 is configured to receive identifying information for one or more individuals that are at or near the non-law enforcement facility. In such an embodiment, the access point 102 can be located at an entrance to, a gate of, a lobby of, or reception of the non-law enforcement facility. As such, the access point 102 is located at a location that can control access to the rest of the non-law enforcement facility.

In an embodiment, the access point 102 is configured to receive identifying information for one or more individuals before the one or more individuals are at or near the non-law enforcement facility (e.g., pre-screen the one or more individuals). In an example, the one or more individuals can provide their identifying information directly to the access point 102 before the one or more individuals are at or near the non-law enforcement. In such an example, the access point 102 can be connected to the internet and configured to receive the identifying information directly from the one or more individuals (e.g., via a web application or a computer readable form that is transmitted to the access point 102). In an example, the one or more individuals can provide their identifying information indirectly to the access point 102 before the one or more individuals are at or near the non-law enforcement. In such an example, the access point 102 can be located at or near a communication device, such as near a telephone (e.g., at reception, at a call center) or a computer with email access. The one or more individuals can send their identifying information to the communication device and an person using the communication device can input the identifying information into the access point 102. Configuring the access point 102 to receive identifying information before the one or more individuals are at or near the non-law enforcement facility can at least one of prevent potential socially awkward situations where the one or more individuals are denied access to the non-law enforcement facility, screen one or more dangerous individuals before they are present at the non-law enforcement facility, or expedite the screening process since the one or more individuals can be pre-screened.

In an embodiment, the access point 102 is configured to receive identifying information for one or more individuals that are attempting to virtually access the non-law enforcement facility (e.g., an individual performing maintenance or any other service on the non-law enforcement facility's servers or other critical equipment). For example, the access point 102 can be connected to the Internet and can receive the identifying information from one or more individuals attempting the virtually access the non-law enforcement facility. The access point 102 can be coupled to or form part of a firewall or other security feature that prevents virtual access to the non-law enforcement facility. In such an embodiment, the firewall or other security feature only provides virtual access to the non-law enforcement facility only after the access point 102 indicates to the firewall or other security feature that the one or more individuals are cleared (e.g., after the access point 102 receives a “cleared” message from the communication server 104).

In an embodiment, the access point 102 is configured to receive identifying information for one or more individuals that currently have access to the non-law enforcement facility (e.g., an employee of the non-law enforcement facility). For example, the one or more individuals that currently have access to the non-law enforcement facility may have been given access to the non-law enforcement facility after a conventional background check was performed or the system 100 provided a “cleared” message. The system 100 can be configured to periodically check (e.g., automatically check or check responsive to input) the one or more individuals that currently have access to the non-law enforcement facility to ensure that nothing has changed that may prevent the one or more individuals from continuing to access the non-law enforcement facility. In such an embodiment, the access point 102 can be located at human resources department of the non-law enforcement facility or at another suitable location.

The access point 102 can also include a first communication transceiver 128. The first communication transceiver 128 couples (e.g., communicably couples) the access point 102 to at least the communication server 104. For example, the first communication transceiver 128 can include a WiFi device, a mobile wireless communication device, a Bluetooth device, a local area network device (e.g., network interface or adaptor), a wide area network (e.g., internal or external modem), another suitable network, etc. The first communication transceiver 128 directly communicably couples or indirectly communicably couples (e.g., via the communication server 104) the access point 102 to the local database 108 and/or the government database 114.

The communication server 104 can include a second communication transceiver 130. The second communication transceiver 130 couples (e.g., communicably couples) the communication server 104 to at least the access point 102. The second communication transceiver 130 can also couple the communication server 104 to at least one of the local database 108, the at least one government database 114 (e.g., to the government database 114 via a state message switch), etc. For example, the second communication transceiver 130 can be configured to transmit at least the identifying information to at least one of the local database 108 or the government database 114. The second communication transceiver 130 can also be configured to receive at least one of the local result of the search of the local database 108 or the government result of the search of the government database 114. Further, the second communication transceiver 130 can transmit at least a portion of the local result and/or government result to the access point 102 or the law enforcement agency 116. The second communication transceiver 130 can include any of the communication devices disclosed herein.

The communication server 104 also includes a central processing unit (“CPU”) 132. The CPU 132 is configured to transfer the information between the different components of the system 100, converting a first message (e.g., a first request) that is received by the communication server 104 into a second message (e.g., a third request as discussed below), verify permissions, etc. As such, the CPU 132 can include MSM (not shown) that stores programs and/or information thereon and at least one processor (not shown) that executes the programs.

In an embodiment, the communication server 104 (e.g., the CPU 132) is configured to determine whether the person using the access point 102 generating the first request has permission to generate the first request. For example, the communication server 104 can verify the identity of the person using the access point 102 by requiring the person to log onto the access point 102 or the communication server 104, an OAUTH protocol, or using any other suitable protocol. In another example, the communication server 104 can verify that the person is authorized to generate the first request according to one or more permissions. The permissions can be stored on the MSM of the communication server 104 or the access point 102 (e.g., the first request includes the permissions). The permissions can be determined by an administrator prior to the generation of the first request. The permissions can indicate what searches that person is authorized to conduct. The permissions can be set based on the person's access to a government database 114, whether the person is a partner or sponsor, etc. In another example, the communication server 104 can determine whether the person is a sponsor, a partner, and/or whether the partner includes a sponsor. In another example, the communication server 104 can verify that the first request originated from the access point 102 and not another device. Such verification can be done using transport layer security, secure sockets layer, another communication security protocol, logging onto the communication server 104, etc. In another example, the CPU 132 can analyze the originating agency identifier (“ORI”) of the access point 102.

In an embodiment, responsive to receiving a request from the access point 102, the CPU 132 of the communication server 104 can determine where to send the identifying information contained in the request. In an example, the communication server 104 can receive a first request directing the communication server 104 to query (e.g., transmit the identifying information to) the local database 108. In such an example, the communication server 104 can transmit at least the identifying information to the local database 108. In an example, the first request received by communication server 104 can direct the communication server 104 to query both the local database 108 and the government database 114. In an example, the first request received by the communication server 104 can provide instructions to query the government database 114 depending on an analysis of the local result by the communication server 104. In such an example, the instructions can include directing the communication server 104 to query the government database 114 if the identifying information did not match any information stored on the local database 108 or the local result received by the communication server 104 is out-of-date (e.g., older than about 3 months, older than about 6 months, older than about a year, older than about 2 years, or older than about 5 years). In an example, the communication server 104 can receive a second request from the access point 104 after receiving the first request (e.g., after sending an analysis of the local result to the access point 102) and the second request can direct the communication server 104 to query the government database 114. In an example, the communication server 104 can include one or more instructions stored on the MSM thereof to query the government database 114 depending on an analysis of the local result by the communication server 104. In such an example, the instructions can include directing the communication server 104 to query the government database 114 if the identifying information did not match any information stored on the local database 108 or the local result received by the communication server 104 is out-of-date.

As previously discussed, the communication server 104 can transmit the identifying information to the local database 108. As will be discussed in more detail below, the local database 108 can scan the information stored therein to determine if there is a match between the information stored in the local database 108 and the identifying information. Responsive to scanning the information stored in the local database 108, the local database 108 can transmit a local result that contains the result of the search of the local database 108 to the communication server 104. In an embodiment, the communication server 104 (e.g., the CPU 132) can analyze the information contained in the local result. For example, analyzing the local result can include determining whether the local result discloses that the individual in question was permitted entrance or was denied entrance. In another example, the communication server 104 can determine that the local result constitutes a nondisqualifying match. The nondisqualifying match is when (1) the identifying information did not match any records of the local database 108 or (2) the identifying information did match at least one record of the local database 108 but did not meet one or more entrance criteria. In such an example, the communication server 104 can transmit a “cleared” message to the access point 102. The “cleared” message can include any suitable message that indicates that the identifying information did not match any entrance criteria. In another example, the communication server 104 can determine that the local result constitutes a potential disqualifying match. The potential disqualifying match is when the identifying information matched at least one record of the local database 108 and the match did meet one or more of the entrance criteria. In such an example, the communication server 104 can transmit a “not-cleared” message to the access point 102 or, as will be discussed in more detail below, transmit at least a portion of the government result to the law enforcement agency 116. Responsive to transmitting at least a portion of the government result to the law enforcement agency 116, the communication server 104 102 can transmit a “pending” message to the non-law enforcement facility 102 or wait for further communication from the law enforcement agency 116.

In an embodiment, the CPU 132 can convert the first request, a second request, and/or any other request received from the access point 102 to create a third request that is transmitted to and complies with the requirements of the government database 114. For example, the CPU 132 can extract the identifying information and any other information needed to search the government database 114 from the request(s) received from the access point 102 and create the third request from the extracted information. In an example, the third request can include an NCIC query wanted message.

In another embodiment, the communication server 104 (e.g., the CPU 132) can analyze the information contained in the government result. For example, the communication server 104 can determine that the government result constitutes a nondisqualifying match. In such an example, the communication server 104 can transmit a “cleared” message to the non-law enforcement facility 102. In another example, the communication server 104 can determine that the government result constitutes a potential disqualifying match. In such an example, the communication server 104 can transmit a “not-cleared” message to the non-law enforcement facility 102 or, as discussed in more detail below, transmit at least a portion of the government result to the law enforcement agency 116. Responsive to transmitting at least a portion of the government result to the law enforcement agency 116, the communication server 104 102 can transmit a “pending” message to the non-law enforcement facility 102 or wait for further communication from the law enforcement agency 116.

In an embodiment, CPU 132 can parse at least one the local or government results received by the communication server 104. In an example, the CPU 132 can parse the local or government result to just a “cleared” message, a “not cleared” message, which entrance criteria was triggered, etc. In an example, the CPU 132 can remove certain information from the local or government result (e.g., confidential information, extraneous information, etc.) prior to transmitting the local or government result to one or more components of the system 100. In an example, the CPU 132 can delete all of the government result except whether a “cleared” or “not cleared” message was sent to the access point 102 and/or a type of NCIC or CJIS alert (e.g., which entrance criteria was trigger) was received by the communication server 104.

In an embodiment, the at least one communication server 104 includes a single server that is configured to perform all of the functions of the communication server 104 and includes the second communication transceiver 130 and the CPU 132. In an embodiment, the at least one communication server 104 includes a plurality of communication servers 104 that are each communicably coupled together. For example, each of the plurality of communication servers 104 are substantially the same. In another example, at least some of the plurality of communication servers 104 are different. For instance, at least some of the plurality of communication servers 104 include different components or are configured to perform different functions. In another example, at least one of the plurality of communication servers 104 are communicably coupled to different components of the system 100 (e.g., a first communication server 104 is communicably coupled to the access point 102 and a second communication server 104 is communicably coupled to the local database 108). In another example, at least some of the plurality of communication servers 104 are at the same location. In another example, at least some of the plurality of communication servers 104 are at different locations. For instance, at least one of the plurality of communication servers 104 is within direct government control and at least one of the plurality of communication servers 104 is not under law enforcement only control.

As previously discussed, the local database 108 includes information stored thereon that can be searched to determine if there is an at least partial match between the identifying information of the first request and the information stored on the local database 108. As such, the local database 108 can include MSM (not shown) that includes information stored thereon and is searchable. Similarly, the local database 108 can be stored on the MSM of a general purpose or special purpose computer that includes at least one processor that is configured to search the local database 108. Additionally, a general purpose or special purpose computer that stores the local database 108 can include a third communication transceiver 134 that is configured to receive at least the identifying information from the communication server 104 and transmit the local result of the search of the local database 108 to the communication server 104. The third communication transceiver 134 can include any of the communication transceivers disclosed herein.

There is an at least partial match when at least one item of identifying information of the individuals (e.g., name, driver's license number, license plate number, etc.) matches at least one item of identifying information stored on the local database 108. For example, there is an at least partial match when the identifying information of the individuals includes only a single item of identifying information and the single item of identifying information matches at least one stored on the local database 108. In another example, there is an at least partial match when the identifying information of the individuals can include a plurality of items of identifying information of the individuals and at least one of the plurality of items identifying information matches at least one item of identifying information stored on the local database 108. In another example, there is an at least partial match when the identifying information of the individuals can include a plurality of items of identifying information of the individuals and all of the plurality of items identifying information matches a plurality of items of identifying information stored on the local database 108. There is no match when no item of the identifying information of the individuals matches an item of identifying information stored on the local database 108.

The information stored on the local database 108 can include a plurality of previous government results stored thereon. Each previous government results include at least a portion of a government result of a previous search of the governmental databases 114. For example, a previous request may have been sent from the access point 102, which resulted in a search of a government database 114 and a previous government result being generated. At least a portion of the previous government result is then stored on the local database 108. For example, at least one of the entire previous government result, a portion of the previous government result, what entrance criteria the previous government result triggered, whether a “cleared” or “not cleared” message was generated responsive to the previous government result, or whether the individuals were granted or denied access can be stored on the local database 108. Additionally, the previous government result can be associated with identifying information that is stored on the local database 108 and was used to generate the previous government result. The amount of information stored on the local database 108 can be restricted based on statutes, regulations, government agency's restrictions, an agreement with the sponsor, etc. In an embodiment, the local database 108 can include additional information stored thereon. The additional information can include the image of the identifying information that was captured at the access point 102, the entity requesting the previous search, the date and time of the previous request, or any other information.

The processor of the general purpose or special purpose computer that stores the local database 108 can be configured to search the local database 108 responsive to receiving the identifying information from the communication server 104. For example, the processor of the local database 108 can compare the identifying information of the first request against the identifying information stored on the local database 108. The local database 108 can be configured (e.g., via the third communication transceiver 134) to transmit the local result of the search of the communication server 104.

In an embodiment, the at least one local database 108 includes a single local database 108. In an embodiment, the at least one local database 108 includes a plurality of local databases 108. For example, each of the plurality of local databases 108 are owned by the same entity and/or are at the same location. In another example, at least some of the plurality of local databases 108 are owned by different entities and/or are at different locations. In another example, at least some of the plurality of local databases 108 include similar information. In another example, at least some of the plurality of local databases 108 include different information.

In an embodiment, as illustrated in FIG. 1, at least one of (e.g., all of) the access point 102, the communication server 104, and the local database 108 can be not under law enforcement only control. Instead, at least one of the access point 102, the communication server 104, and the local database 108 are at least partially under the control of a third party. As used herein, control refers to a parties ability to at least one of control the software of a computer device, access the data of the computer device, or otherwise administer or manage the computer device. At least partially controlling at least one of the access point 102, the communication server 104, or the local database 108 with a third party decreases the burden on law enforcement agencies and law enforcement agencies' computer systems since it allows third parties and third parties' computer systems to manage and administer at least one of the access point 102, the communication server 104, and the local database 108 thereby freeing law enforcement resources for other uses.

It is noted that a third party at least partially controlling at least one of the access point 102, the communication server 104, or the local database 108 does not preclude at least one of the access point 102, the communication server 104, or the local database 108 from being at least partially controlled by a law enforcement agency and/or from being audited by the law enforcement agency. Further, a third party at least partially controlling at least one of the access point 102, the communication server 104, or the local database 108 does not preclude at least one of the access point 102, the communication server 104, or the local database 108 from being located on law enforcement or law enforcement controlled property, such as in a precinct or at the National Law Enforcement Telecommunications Systems.

In an embodiment, the access point 102, the communication server 104, and the local database 108 are distinct devices. For example, at least two of the access point 102, the communication server 104, or the local database 108 are located in different locations. In another example, the access point 102, the communication server 104, and the local database 108 form at least a portion of different general purpose or special purpose computers. However, in an embodiment, at least two of the access point 102, the communication server 104, or the local database 108 are integrated. For example, at least two of the access point 102, the communication server 104, or the local database 108 may form part of the same general purpose or special purpose computer. In such an example, the access point 102, the communication server 104, or the local database 108 can share components (e.g., the local database 108 can be stored on the MSM 118 or the CPU 132 and the local database 108 can be searched using the processor 120 or the CPU 132).

The government database 114 can include any government database 114 that has restricted access and is searchable. In an embodiment, the government database 114 can include any database that is under the control and/or updated by the Federal Bureau of Investigation or another law enforcement agency, such as the CJIS and/or the NCIC databases. In an embodiment, the government database 114 can include a criminal records database (other than the CJIS and/or NCIC databases) that are maintained by a municipal, state, or federal government agency. In an embodiment, the government database 114 can include MAINWAY managed by the National Security Agency, the Census databases managed by the Census Bureau, Federal Data Services Hub managed by the Internal Revenue Service, the Mail Isolation Control and Tracking databases managed by the United Postal Service, the Integrated Automated Fingerprint Identification System managed by the FBI, the Next Generation Identification database managed by the FBI, the Combined DNA Index System managed by the FBI, the Internal Revenue Service database managed by the Internal Revenue Service, the Social Security Death Index managed by the Social Security Administration, driver license and/or motor vehicle registry managed by state department of motor vehicles, or any other suitable municipal, state, or federal government database 114. In an embodiment, the government database 114 can include a foreign (e.g., non-United States) government database 114. In an embodiment, the at least one government database 114 can include a plurality of government databases 114, such as a combination of any of the government databases 114 disclosed herein.

As previously discussed, in some embodiments, the communication server 104 can transmit at least a portion of the government result of the search of the government database 114 to an law enforcement agency 116, for example, when the communication server 104 determines that the government result is associated with at least one entrance criteria or is unsure if the government result is associated with at least one entrance criteria. The law enforcement agency 116 can include any agency or group that is authorized to view the government result. For example, the law enforcement agency 116 can include a federal law enforcement organization or officer (e.g., the FBI, National Security Agency, the Bureau of Alcohol, Tobacco, Firearms, and Explosives, etc.), a state or municipal law enforcement organization or officer, or another suitable agency or individual. In an embodiment, the law enforcement agency 116 can include a general purpose or special purpose computer that receives at least a portion of the government result. In an embodiment, the law enforcement agency 116 can include an individual (e.g., police office, FBI special agent, etc.) that reviews the government result on the general purpose or special purpose computer. The individual can decide at least one of if the government result triggers an entrance criteria, what information is actually confidential, which information is sent to the communication server 104 (e.g., a “cleared” or “not cleared” message), etc. In an embodiment, the government result is reviewed by the general purpose or special purpose computer using instructions stored on a memory storage medium thereof before, after, or without transmitting the government result to an individual for review. It is noted that the communication server 104 can transmit a “reviewed” messages along with the “cleared” or “not cleared to the access point 102 when the law enforcement agency 116 reviewed the government result. The “reviewed” message can include any message indicating that the law enforcement agency 116 reviewed the government result.

In an embodiment, the communication server 104 can select between a plurality of different law enforcement agencies 116 and transmit at least a portion of the government result to the selected law enforcement agency 116. For example, the communication server 104 can select a government agency that may be interested in the one or more individuals and/or the non-law enforcement facility. For example, the communication server 104 can transmit at least a portion of the government result to a federal law enforcement agency if the government result included a federal arrest warrant and the communication server 104 can transmit at least a portion of the government result to a state or municipal law enforcement agency if the government result included a non-federal arrest warrant.

In an embodiment, the law enforcement agency 116 is omitted from the system 100. For example, the communication server 104 can determine that the government result is associated with at least one entrance criteria and the communication server 104 can transmit a “not cleared” message to the access point 102. Whether or not the law enforcement agency 116 can be omitted from the system 100 may depend on current government rules, regulations, or restrictions.

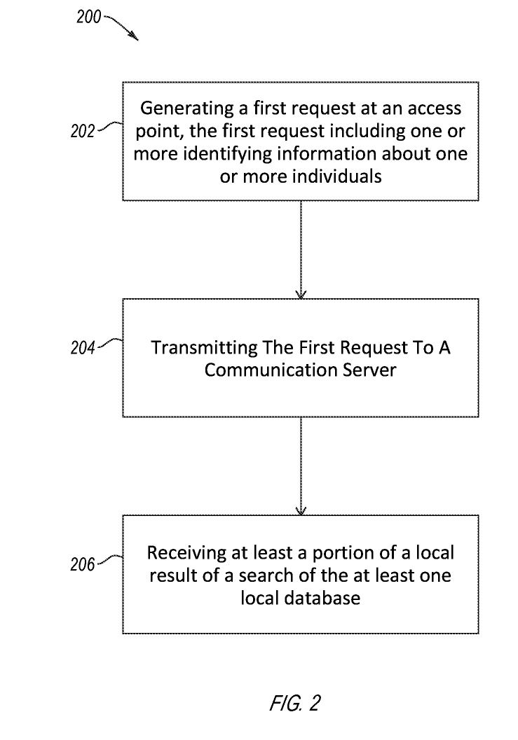

FIG. 2 is a flow chart of a method 200 to screen one or more individuals using the system 100 of FIG. 1, according to an embodiment, from the perspective of the access point 102. In an embodiment, some of the acts of method 200 can be split into a plurality of acts, some of the acts can be combined into a single act, and some acts can be omitted. Also, it is understood that additional acts can be added to the method 200. Except as otherwise disclosed herein, the acts of method 200 can be used with any of the systems disclosed herein.

Act 202 of the method 200 includes, at the access point 102, “generating a first request at an access point 102, the first request including one or more identifying information about one or more individuals.” For example, a single individual or a plurality of individuals can enter a lobby, a security gate, an entrance, or another portion at and/or near the non-law enforcement facility. A person using the access point 102 and/or a person responsible for screening individuals entering the non-law enforcement facility (e.g., an employee, a security guard, business owner, property owner, etc.) can obtain identifying information about the single individual or at least some (e.g., each) of the plurality of individuals. The identifying information can include name, social security number, driver license number, license plate number, physical description, fingerprint, facial recognition, etc. The person can enter the identifying information into the access point 102. For example, the person can enter the identifying information using a touchscreen, keyboard, an image capturing device, etc. In an embodiment, the person can input which entrance criteria are used to screen the individuals or the entrance criteria can be preselected. In some embodiments, the access point 102 can require the person to log into the access point 102 or a program on the access point 102 to verify the identity of and/or permissions granted to the person.

Act 204 of the method 200 includes, at the access point 102, “transmitting the first request to a communication server 104.” For example, the access point 102 can transmit the first request wiredly (e.g., via an Ethernet connection) or wirelessly (e.g., via WiFi) to the communication server 104 using the first communication transceiver 128. The first request can include the identifying information of a single individual or a plurality of individuals. From another perspective, act 204 includes, at the communication server 104, receiving the first request from the access point 102. For example, the second communication transceiver 130 can receive the first request from the access point 102.

In an embodiment, the method 200 includes transmitting a request (e.g., the first request or another request) that includes the identifying information from the access point 102 to the local database 108. For example, the request can be transmitted from the access point 102 directly to the local database 108 (e.g., before or after act 204) or indirectly via the communication server 104 (e.g., after act 204).

Act 206 of the method 200 includes “receiving at least a portion of a local result of a search of the at least one local database 108.” For example, act 206 can include receiving the local result directly from the local database 108. In another example, act 206 can include receiving the local result indirectly from the local database 108 via the communication server 104. In such an example, the access point 102 can receive the entire local result or a portion of the local result received by the communication server 104 from the local database 108. A portion of the local result received by the access point 102 can include a locally “cleared” or locally “not cleared” message, a portion of the local result including confidential information removed therefrom, a portion of the local result that includes extraneous information removed therefore, or combinations thereof. For example, the local result stored on the local database 108 can include whether the identifying information was or was not associated with at least one entrance criteria. In such an example, the portion of the local result received by the access point 102 can merely include a locally “cleared” or “not cleared” message. Act 206 can be performed using the first communication transceiver 128.

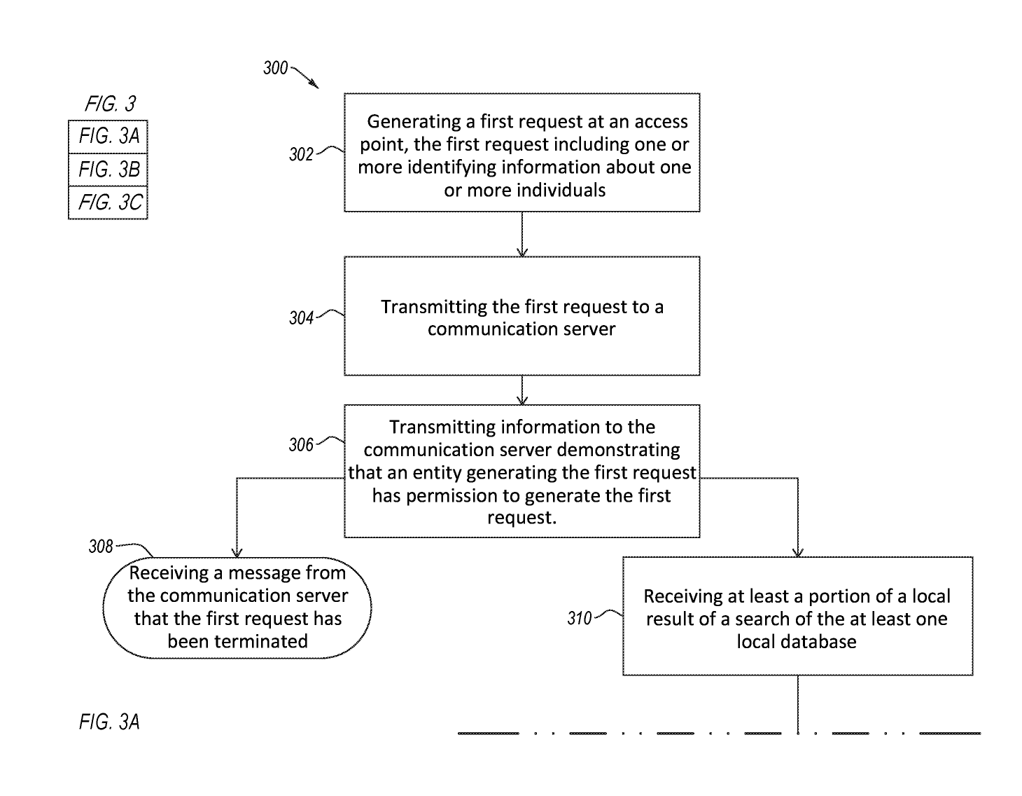

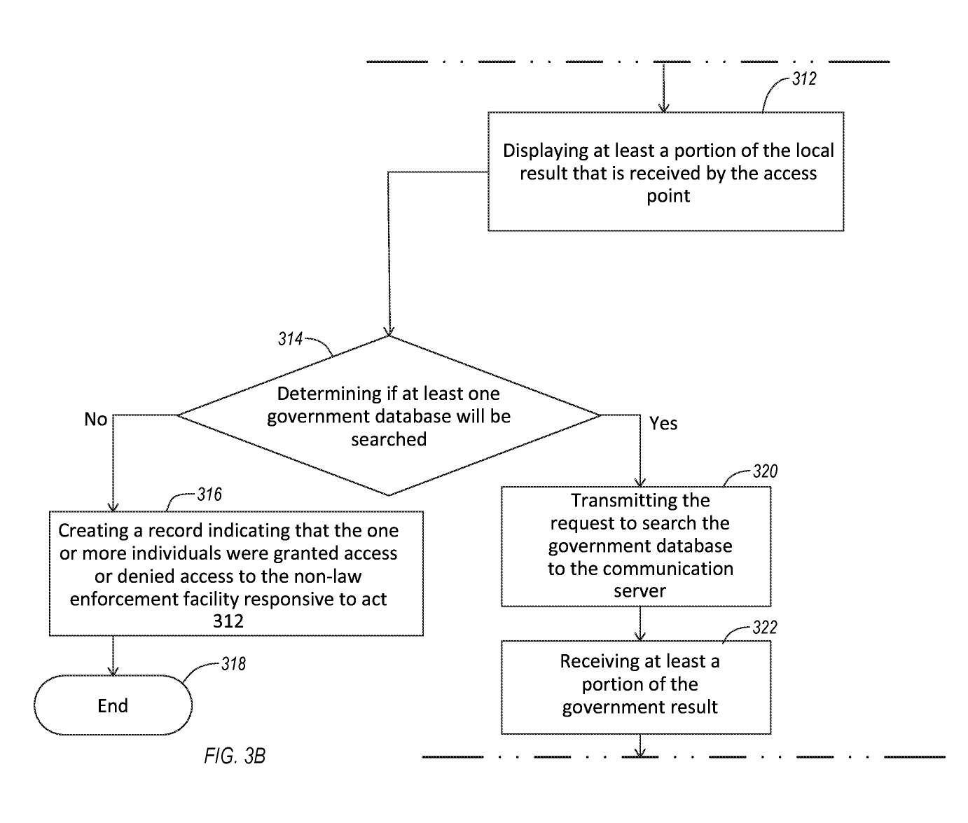

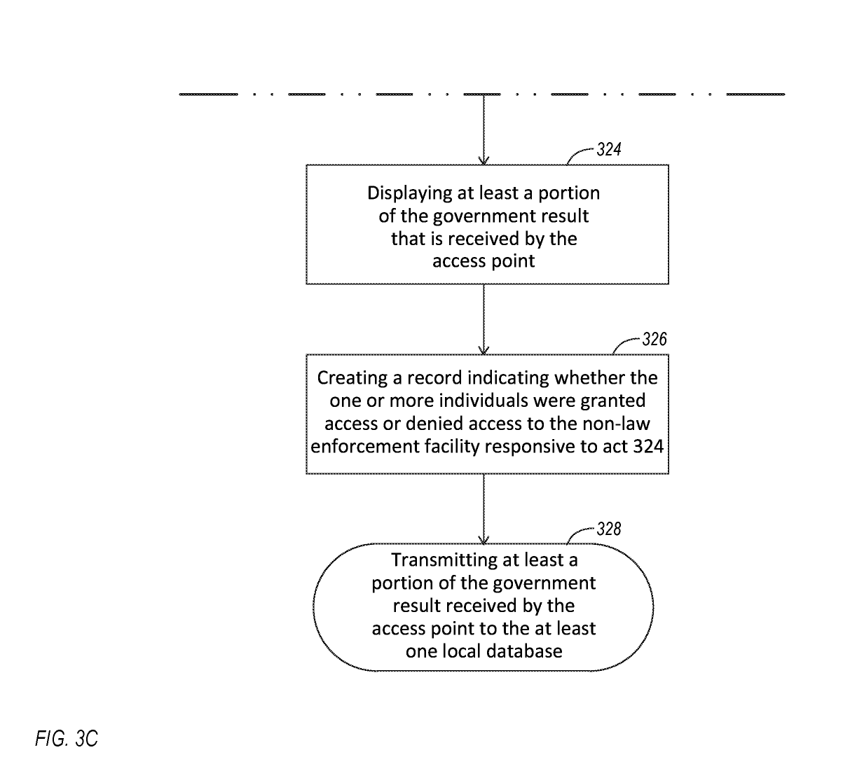

FIG. 3 is a flow chart of a method 300 to screen one or more individuals the system 100 of FIG. 1, according to an embodiment, from the perspective of the access point 102. For ease of illustration, FIG. 3 has been split into FIGS. 3A, 3B, and 3C. In an embodiment, some of the acts of method 300 can be split into a plurality of acts, some of the acts can be combined into a single act, and some acts can be omitted. Also, it is understood that additional acts can be added to the method 300. Except as otherwise disclosed herein, the acts of method 300 can be used with any of the systems disclosed herein.

Act 302 of the method 300 includes, at the access point 102, “generating a first request at an access point 102, the first request including one or more identifying information about one or more individuals.” Act 302 can be the same as or similar to act 202 of method 200. Act 304 of method 300 includes, at the access point 102, “transmitting the first request to a communication server 104.” Act 304 can be the same as or similar to act 204 of method 200. Act 302 can be performed using a processor 120 of the access point 102.

Act 306 of the method 300 includes, at the access point 102, “transmitting information to the communication server 104 demonstrating that a person generating the first request has permission to generate the first request.” For example, the access point 102 can transmit to the communication server 104 at least one of that the person has successfully logged onto the access point 102, proof of OAUTH protocol was successfully initiated, that an administrator has granted permission to the person to generate the first request, transport layer security or other security protocols verifying that the access point 102 generating the first request is valid access point 102 (e.g., not a hacker), information demonstrating that person entity is a sponsor or a partner associated with the sponsor, etc. Act 306 can be performed using the first communication transceiver 128.

In an embodiment, the communication server 104 determines, based on the information transmitted by the access point 102, that the person does not have permission to generate the first request. In such an embodiment, act 308 of the method 300 includes “receiving a message from the communication server 104 that the first request has been terminated.” In response to act 308, the person generating the first request can restart the method 300 or terminate the method 300. Act 308 can be performed using the first communication transceiver 128.

In an embodiment, the communication server 104 determines, based on the information transmitted by the access point 102, that the person does have permission to generate the first request. In such an embodiment, act 310 of method 300 includes, at the access point 102, “receiving at least a portion of a local result of a search of the at least one local database 108.” For example, act 310 includes receiving at least a portion of the local result directly from the local database 108 or indirectly from local database 108 via the communication server 104. Act 310 is the same as or similar to act 406 of method 400.

In an embodiment, the communication server 104 parses (e.g., analyzes) the local result to determine whether or not the information contained in the local result is associated with at least one entrance criteria prior to act 310 (e.g., act 310 includes receiving at least a portion of the local result indirectly from the local database 108 via the communication server 104). However, in another embodiment, the communication server 104 does not parse the local result to determine whether or not the local result is associated with at least one entrance criteria . For example, the method 300 can include, with the processor 120 of the access point 102, parsing the local result to determine whether or not the local result is associated with one or more entrance criteria based on the information contained in the local result. In another example, the local result already includes a “cleared” or “not cleared” message therein based on a previous analysis and the access point 102 merely receives the “cleared” or “not cleared” message of the local result.

After act 310, act 312 of method 300 includes, with the display 124 of the access point 102, “displaying at least a portion of the local result that is received by the access point 102.” For example, act 312 includes displaying a locally “cleared” message. In another example, act 312 includes displaying a locally “ not cleared” message. In another example, act 312 includes displaying additional information instead of or in conjunction with the locally “cleared” or “not cleared” message, such as the at least one entrance criteria that was triggered by the local result.

Act 314 of the method 300 includes, at the access point 102, “determining if at least one government database 114 will be searched.” Act 314 can be performed before, during, or after at least one of act 302, 304, 306, 310, or 312. In an embodiment, the first request includes a request to search the government database 114 or provides instructions to query the government database 114 depending on an analysis of the local result by the communication server 104. In an embodiment, the access point 102 generates a second request after generating the first request (e.g., after receiving at least a portion of the local result). The second request includes at least a request to search the at least one government database 114. The second request can also include the identifying information of the individuals. The second request can be different than, similar to, or the same as the first request. Act 314 can be performed using the processor 120 of the access point 102.

In an embodiment, during act 314, it is determined at the access point 102 that a search of the government database 114 will not be request. In such an embodiment, the method 300 can include act 316 which 300 includes, at the access point 102, “creating a record indicating that the one or more individuals were granted access or denied access to the non-law enforcement facility responsive to act 312.” For example, act 312 include displaying a locally “cleared” message and, responsive to the locally “cleared” message, the person operating the access point 102 grants the one or more individuals access to the non-law enforcement facility. In such an example, act 316 includes creating a record indicating that the one or more individuals were granted access. In another example, act 312 includes displaying a locally “not cleared” message and, responsive to the locally “not cleared” message, the person operating the access point 102 denies the one or more individuals access to the non-law enforcement facility. In such an example, act 316 includes creating a record indicating that the one or more individuals were denied access. In another example, act 312 includes displaying a locally “cleared” or “not cleared” message and, responsive to the locally “cleared” or “not cleared” message, the person operating the access point 102 decides to search at least one government database. In such an example, act 316 includes creating a record indicating that the one or more individuals were denied access (e.g., pending the results of the search of the government database). In an embodiment, the record created in act 316 can be stored on the access point 102 or the local database 108. The record created in act 316 can be used for record keeping and auditing purposes.

After act 316, the method 300 can include act 318. Act 318 includes terminating the method 300 without searching the government database 114. For example, act 318 includes transmitting a message from the access point 102 to the communication server 104 cancelling the method 300.

In an embodiment, during act 314, it is determines that a search of the government database 114 will be requested. In such an embodiment, act 320 of method 300 includes “transmitting the request to search the government database 114 to the communication server 104.” Act 320 can be the same as act 302 (e.g., the first request includes the request to search the government database 114 or includes instructions detailing when the government database 114 is to be searched) or different than act 302 (e.g., the access point 102 generates a second request and transmits the second request to the communication server 104). Act 320 can be performed using the first communication transceiver 128.

From another perspective and as will be discussed in more detail hereafter, responsive to act 320, the communication server 104 can receive the request to search the government database 114. The communication server 104 can then transmit at least the identifying information of the individuals to at least one government database 114. The government database 114 can receive the information transmitted thereto by the communication server 104 and can search the government database 114 responsive to receiving the information. The government database 114 can generate a government result of the search of the government database 114 that includes whether or not the government database 114 found an at least partial match between the identifying information of the individuals and the identifying information stored on the government database 114. The government result can include the identifying information stored on the government database 114 that at least partially matched the identifying information of the individuals and/or any information stored on the government database 114 associated with the identifying information stored on the government database 114. The government database 114 can transmit the government result to the communication server 104. The communication server 104 can receive the government result from the government database 114 and transmit at least a portion of the government result received thereby to the access point 102.

Act 322 of the method 300 includes, at the access point 102, “receiving at least a portion of the government result.” For example, the access point 102 can receive the entirety of the actual government result. In another example, the access point 102 can receive a portion of the actual government result (e.g., the communication server 104 removed confidential or extraneous information from the government result). The amount of information received can depend on current and future laws and regulations. In another example, the access point 102 can receive information derived from the actual government result, such as at least one of a “cleared,” “not cleared,” or “pending” message from the communication server 104 (e.g., prior to act 322, the communication server 104 parses the government result to determine whether or not the government result is associated with at least one entrance criteria).

In an embodiment (not shown), the processor 120 of the access point 102 parses the government result instead of the communication server 104 to determine whether or not the government result is associated with at least one entrance criteria.

After act 322, act 324 of the method 300 includes, with the display 124 of the access point 102, “displaying at least a portion of the government result that is received by the access point 102.” For example, act 324 includes displaying a “cleared” message. In another example, act 324 includes displaying a “not cleared” message. In another example, act 324 includes displaying additional information instead of or in conjunction with the “cleared” or “not cleared” message, such as the at least one entrance criteria that was triggered by the government result.

Act 326 of the method 300 includes, at the access point 102, “creating a record indicating whether the one or more individuals were granted access or denied access to the non-law enforcement facility responsive to act 324.” For example, act 324 include displaying a “cleared” message and, responsive to the “cleared” message, the person operating the access point 102 grants the one or more individual access to the non-law enforcement facility. In such an example, act 326 includes creating a record indicating that the one or more individuals were granted access. In another example, act 324 includes displaying a “not cleared” message and, responsive to the “not cleared” message, the person operating the access point 102 denies the one or more individuals access to the non-law enforcement facility. In such an example, act 326 includes creating a record indicating that the one or more individuals were denied access. In an embodiment, the record created in act 326 can be stored on the access point 102 or the local database 108. The record created in act 326 can be used for record keeping and auditing purposes.

Act 328 of the method 300 includes “transmitting at least a portion of the government result received by the access point 102 to the at least one local database 108.” Act 328 can be performed after act 324 and before or after at least one of acts 326 or 328. The local database 108 can store the information that is transmitted by the access point 102 (e.g., via the communication server 104) and received thereby on the local database 108 to be used in future searches of the local database 108. Act 332 can be performed using the first communication transceiver 128.

As previously discussed, at least some of the act of the method 300 can be omitted. For example, act 328 can be omitted when the communication server 104 transmits at least a portion of the government result on the local database 108. In another example, as previously discussed, the communication server 104 can analyze the local result and, based on instructions stored thereon, the communication server 104 can determine whether the government database is to be searched without receiving communication from the access point 102. In such an embodiment, acts 314, 316, 318, and 320 can be omitted from the method 300. In another example, at least one of the communication server 104 can perform at least one of the acts of method 300 instead of the access point 102.

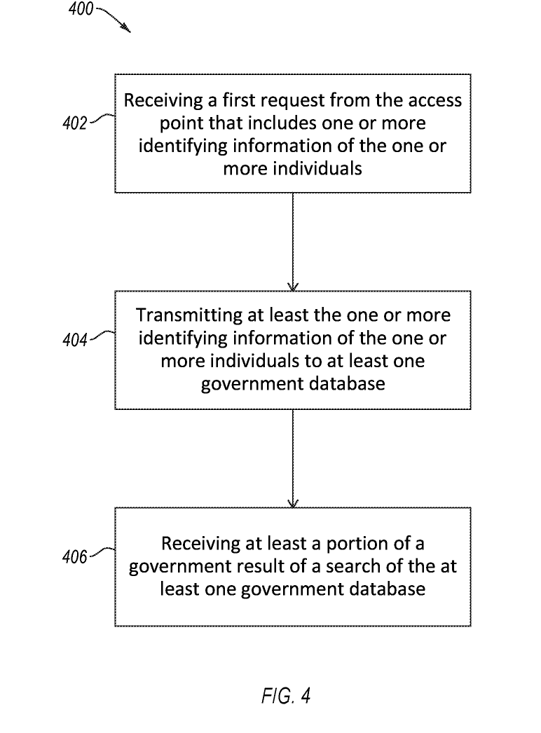

FIG. 4 is a flow chart of a method 400 to screen one or more individuals using the system 100 of FIG. 1, according to an embodiment, from the perspective of the communication server 104. In an embodiment, some of the acts of method 400 can be split into a plurality of acts, some of the acts can be combined into a single act, and some acts can be omitted. Also, it is understood that additional acts can be added to the method 400. Except as otherwise disclosed herein, the acts of method 400 can be used with any of the systems disclosed herein.

Act 402 of the method 400 includes, at the communication server 104 “receiving a first request from the access point 102 that includes one or more identifying information of the one or more individuals.” Act 402 can be responsive to acts 202 or 302 of methods 200 or 300. For example, the second communication transceiver 130 of the communication server 104 can receive the first request from the access point 102. In an embodiment, the first request can include a request to search the government database 114 or can include instructions detailing when the government database 114 is to be searched responsive to an analysis of a local result by the communication server 104. In an embodiment, act 402 also includes receiving a second request from the access point 102 after receiving the first request, the second request including a request to search the government database 114. Act 402 can be performed using the second communication transceiver 130.

Act 404 of the method 400 includes “transmitting at least the one or more identifying information of the one or more individuals to at least one government database 114.” In an example, act 404 can include transmitting the first and/or second requests received from the access point 102 to the government database 114. In an example, act 404 can include transmitting a third request that includes the identifying information of the individuals to the government database 114. The third request is different than the first and/or second requests (e.g., the third request is a NCIC query wanted message). Act 404 can be performed using the second communication transceiver 130 of the communication server 104.

Act 406 of the method 400 includes “receiving at least a portion of a government result of a search of the at least one government database 114.” Act 406 can be performed using the second communication transceiver 130.

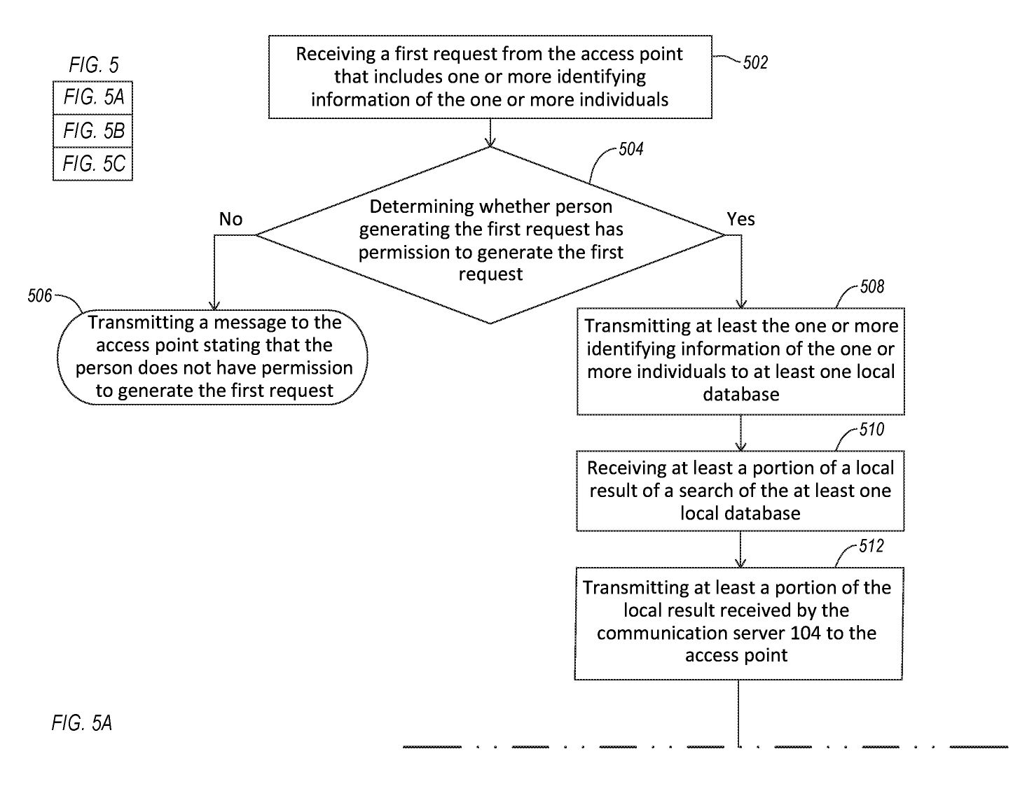

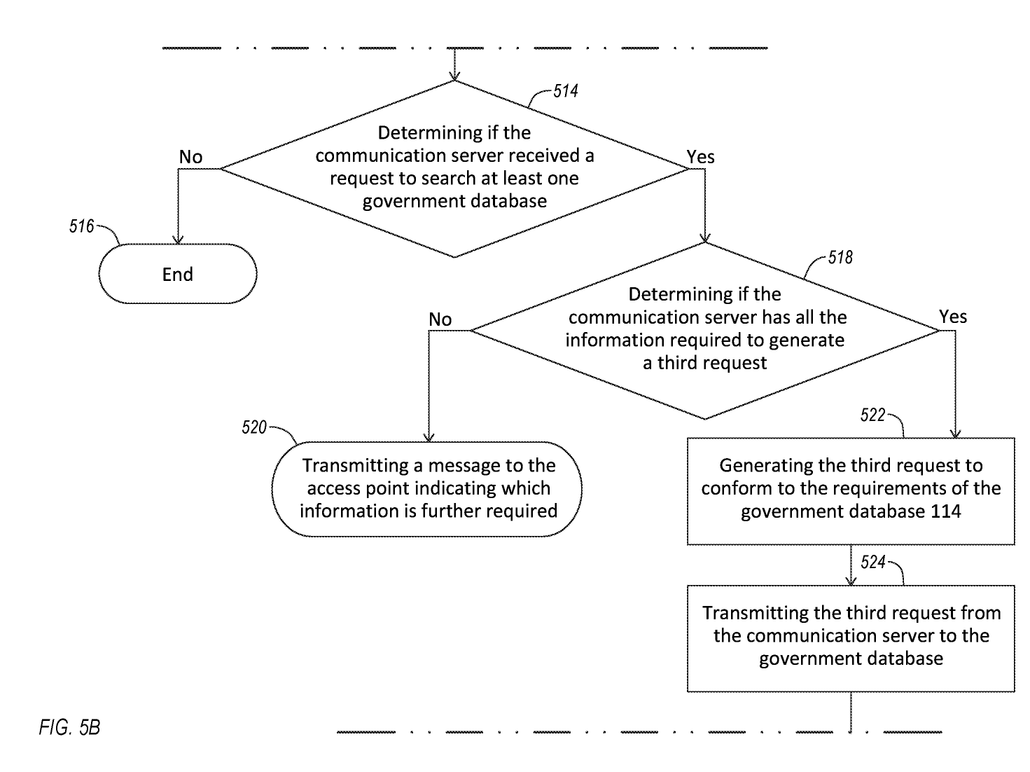

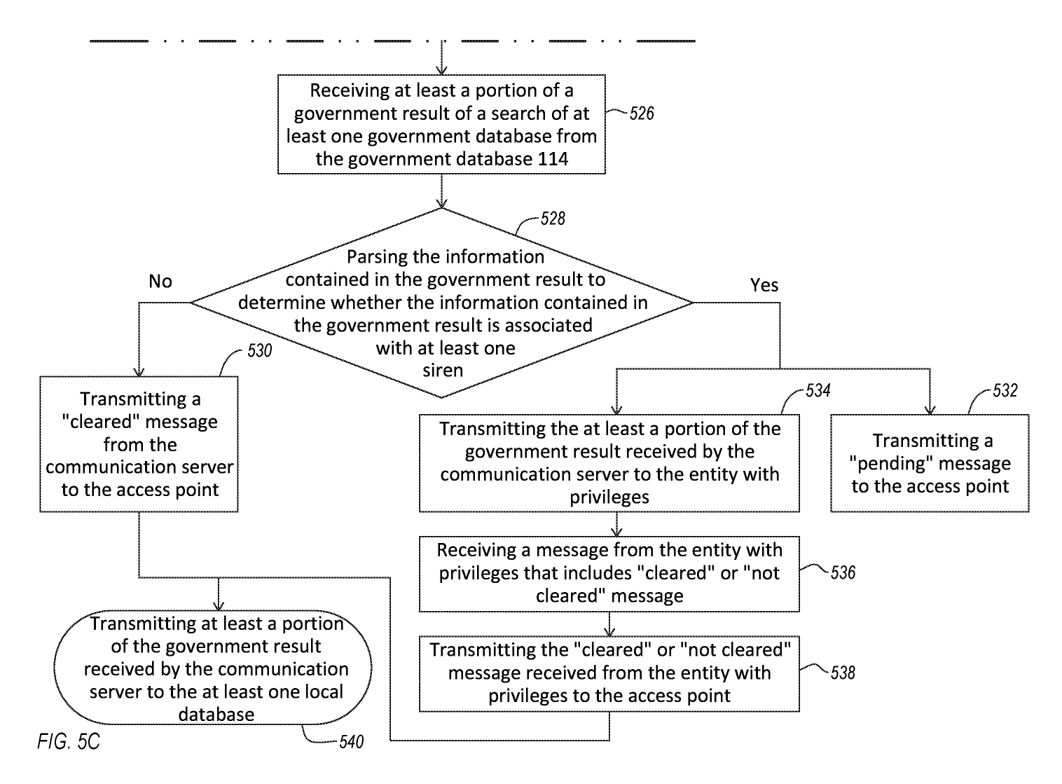

FIG. 5 is a flow chart of a method 500 to screen individuals using the system 100 of FIG. 1, according to an embodiment, from the perspective of the communication server 104. For ease of illustration, FIG. 5 has been split into FIGS. 5A, 5B, and 5C. In an embodiment, some of the acts of method 500 can be split into a plurality of acts, some of the acts can be combined into a single act, and some acts can be omitted. Also, it is understood that additional acts can be added to the method 500. Except as otherwise disclosed herein, the acts of method 500 can be used with any of the systems disclosed herein.

Act 502 of the method 500 includes “receiving a first request from the access point 102 that includes one or more identifying information of the one or more individuals.” Act 502 can be the same as or similar to the act 402 of method 400.

Act 504 of the method 500 includes “determining whether a person generating the first request has permission to generate the first request.” In an embodiment, act 504 can include receiving information from the access point 102 verifying that the person has logged into the access point 102, for example, using an OAUTH protocol. In another embodiment, the communication server 104 can verify that the person is authorized to generate the first request according to one or more permissions. In another embodiment, the communication server 104 can determine whether the person is a sponsor, a partner, and/or whether the partner includes a sponsor. In another example, the communication server 104 can verify that the first request originated from the access point 102 and not another device, for example, using transport layer security, virtual private network, or other security protocols. Act 504 can be performed on the CPU of the communication server 104.

In an embodiment, the communication server 104 can determine that the person does not have permission to generate the first request. In such an embodiment, act 506 of the method 500 includes “transmitting a message to the access point 102 stating that the person does not have permission to generate the first request.” Act 506 effectively terminates the method 500. In an embodiment, the communication server 104 can determine that the person does have permission to generate the first request. In such an embodiment, the method 500 can continue onto act 508. Act 506 can be performed using the second communication transceiver 130.

Act 508 of the method 500 includes, at the communication server 104, “transmitting at least the one or more identifying information of the one or more individuals to at least one local government database 114.” For example, act 508 can include transmitting the first request to the local database 108 or a portion of the first request to the local database 108 (e.g., just the identifying information). Act 508 can be performed using the second communication transceiver 130.

Act 510 of the method 500 can include, at the communication server 104, “receiving at least a portion of a local result of a search of the at least one local database 108.” Act 510 can be performed using the second communication transceiver 130.

In an embodiment, the local result received by the communication server 104 does not need to be parsed (e.g., edited and/or analyzed) by the communication server 104. In such an embodiment, the communication server 104 can transmit the local result directly to the access point 102 without analyzing the local result. For example, the local result can include information indicating whether the previous search of the government result resulted in a “cleared” or “not cleared” message and/or the entrance criteria triggered by the previous government result. In another example, the access point 102 is configured to parse the local result instead of the communication server 104. In an embodiment, the local result received by the communication server 104 needs to be parsed by the communication server 104 to determine whether or not the information contained in the local result is associated with at least one entrance criteria or to compare the local result against instructions contained in the first request to determine whether the government database 114 will be searched. The parsing can be performed using the CPU 132 of the communication server 104.

Act 512 of method 500 includes “transmitting at least a portion of the local result received by the communication server 104 to the access point 102”. For example, the communication server 104 transmits a locally “cleared” or “not cleared” message to the access point 102. In another example, the communication server 104 transmits a locally “cleared” or “not cleared” message to the access point 102 along with additional information contained in the local result. In another example, the communication server 104 transmits at least a portion of the government results without a locally “cleared” or “not cleared” message. In such an example, the access point 102 can parse the portions of the government result received thereby to determine whether the information contained therein is associated with at least one entrance criteria.

From another perspective, the access point 102 can receive the portion of the government result transmitted by the communication server 104 and display at least a portion of the local result received thereby using the display 124.

Act 514 of the method 500 includes “determining if the communication server 104 received a request to search at least one government database 114.” In an embodiment, the communication server 104 determines that the communication server 104 did not receive a request to search at least one government database 114. For example, the first request received by the communication server 104 did not include a request to search the government database 114 or the communication server 104 received a message from the access point 102 cancelling the method 500. In such an embodiment, act 516 of method 500 includes terminating the method 500 without searching the government database 114. In an embodiment, the communication server 104 determines that the communication server 104 received a request to search the government database 114. For example, at least one of the communication server 104 received the second request, the first request included a request to search the government database 114, or the first request included instructions detailing when the government database 114 is to be searched and, responsive to analyzing the local result, the communication server 104 determines that the government database 114 will be searched. In such an embodiment, the method 500 continues to act 518.

Act 518 of the method 500 includes, at the communication server 104, “determining if the communication server 104 has all the information required to generate a third request.” For example, the communication server 104 can analyze the first and/or second requests to determine if the first and/or second requests include all the information required to search the government database 114. For example, the communication server 104 can analyze the first and/or second requests to determine if it includes at least one of the identifying information of the individuals, the person's name generating the request, the non-law enforcement facility, the access point 102, the ORI of the sponsor, or any other information that may be required. Act 522 can be performed using the CPU 132 of the communication server 104.

In an embodiment, the communication server 104 can determine that the first and/or second requests do not include all the information needed. In such an embodiment, act 520 of the method 500 includes “transmitting a message to the access point 102 indicating which information is further required.” Act 520 effectively terminates the method 500 until the communication server 104 receives the missing information. Act 520 can be performed using the second communication transceiver 130. In an embodiment, the communication server 104 determines that it has all the information required to generate the third request. In such an embodiment, the method 500 continues to act 522.

Act 522 of the method 500 includes, at the communication server 104, “generating the third request to conform to the requirements of the government database 114.” For example, the communication server 104 can generate the third request (e.g., a NCIC query wanted message) by converting the first and/or second requests into the third request. In another example, the communication server 104 can generate the third request based on the information contained in the first and/or second requests and any additional information received by or stored on the communication server 104. In an embodiment, the communication server 104 can receive the first and/or second requests from the access point 102 that already comply with the requirements of the government database 114. In such an embodiment, act 522 can be omitted. Act 522 can be performed by the CPU 138 of the communication server 104.

Act 524 of the method 500 includes “transmitting the third request from the communication server 104 to the government database 114.” Act 526 of the method 500 includes “receiving at least a portion of a government result of a search of at least one government database 114 from the government database 114.” Acts 524 and 526 can be the same as or similar to acts 404, 406 of the method 400, respectively.

Act 528 of the method 500 includes “parsing the information contained in the government result to determine whether the information contained in the government result is associated with at least one entrance criteria.” Act 528 can be performed by the CPU 132 of the communication server 104.

In an embodiment, during act 528, the communication server 104 determines that the information contained in the government result is not associated with at least one entrance criteria. In such an embodiment, act 530 of the method 500 includes “transmitting a ‘cleared’ message from the communication server 104 to the access point 102.” Act 530 can be performed with the second communication transceiver 130.

In an embodiment, the communication server 104 determines that the information contained in the government result is associated with at least one entrance criteria or the communication server 104 is unable to determine if the information contained in the government result is or is not associated with at least one entrance criteria. In such an embodiment, the method 500 includes acts 532 and 534. Act 532 of the method 500 includes “transmitting a ‘pending’ message to the access point 102” from the communication server 104. Act 534 of the method 500 includes “transmitting the at least a portion of the government result received by the communication server 104 to the law enforcement agency 116” from the communication server 104. Acts 532 and/or 534 can be performed using the second communication transceiver 130.

Act 536 of method 500 includes, at the communication server 104, “receiving a message from the law enforcement agency 116 that includes a ‘cleared’ or ‘not cleared’ message.” Responsive to act 536, act 538 of method 500 includes, with the communication server 104, “transmitting the ‘cleared’ or ‘not cleared’ message received from the law enforcement agency 116 to the access point 102.” In an embodiment, act 536 can also include transmitting a “reviewed” message to the access point 102 thereby indicating that the government results was reviewed by the law enforcement agency. Acts 536 and/or 538 can be performed using the second communication transceiver 130.

Act 540 of the method 500 includes “transmitting at least a portion of the government result received by the communication server 104 to the at least one local database 108.” Act 540 can be performed after act 526 and before or after at least one of acts 528, 530, 532, 534, 536, or 538. The local database 108 can store the information that is transmitted by the communication server 104 and received thereby on the local database 108 to be used in future searches of the local database 108. Act 540 can be performed using the second communication transceiver 130.

As previously discussed, some of the acts of the method 500 can be omitted. For example, at least one of acts 508-512 can be omitted when the access point 102 at least one of transmits at least the one or more identifying information of the one or more individuals to at least one local government database 114, receives at least a portion of a local result of a search of the at least one local database 108, or determines whether the one or more identifying information is associated with one or more entrance criteria based on the information contained in the local result as disclosed in methods 400 and 300. In another example, at least one of the access point 102, the second server, the government database 114, or the law enforcement agency 116 can perform at least one of the acts of method 500 instead of the communication server 104.

FIG. 6 is a flow chart of a method 600 to screen one or more individuals using the system 100 of FIG. 1, according to an embodiment, from the perspective of the local database 108. In an embodiment, some of the acts of method 600 can be split into a plurality of acts, some of the acts can be combined into a single act, and some acts can be omitted. Also, it is understood that additional acts can be added to the method 600. Except as otherwise disclosed herein, the acts of method 600 can be used with any of the systems disclosed herein.

Act 602 of the method 600 includes “receiving the identifying information of one or more individuals” at the local database 108 or a computer associated therewith. For example, the local database 108 or computer associated therewith can receive the one or more identifying information directly from the access point 102 or indirectly from the access point 102 via the communication server 104. Act 602 can be performed by the third communication device 138.

Act 604 of the method 600 includes “scanning the information stored on the local database 108 to determine if there is a match between the information stored on the local database 108 and the one or more identifying information.” Act 606 of the method 600 includes “generating a local result of the scan of the local database 108.” In an embodiment, the local database 108 did not find any matches between the identifying information and the information stored therein during act 604. In such an embodiment, the local result generated during act 606 can include a message indicating that no matches were found. In an embodiment, the local database 108 found at least one match between the identifying information and the information stored therein during act 604. In such an embodiment, the local result generated during act 606 can include the matching information, any information stored on the local database 108 associated with the matching information, or any other additional information.

Act 608 of the method 600 includes “transmitting the local result to the access point 102.” For example, act 608 can include transmitting the local result directly to the access point 102. In another example, act 608 can include transmitting the local result indirectly to the access point 102 by transmitting the local result to the communication server 104. Act 608 can be performed by the third communication device 134.

Act 610 of the method 600 can include “receiving updated information.” For example, act 610 can include receiving from the access point 102 (e.g., either directly or indirectly from the communication server 104) whether the individuals were allowed or denied entrance into the non-law enforcement facility. In another example, act 610 can include receiving at least a portion of the government result from the communication server 104.

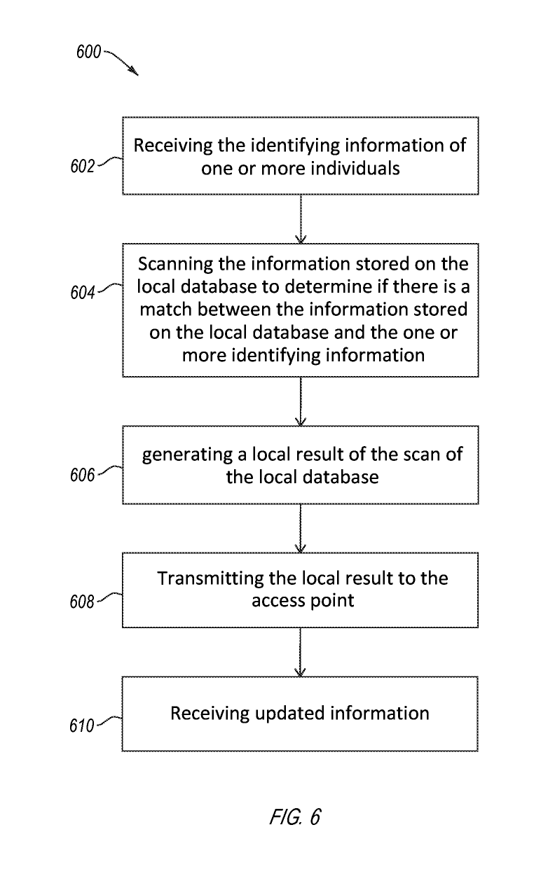

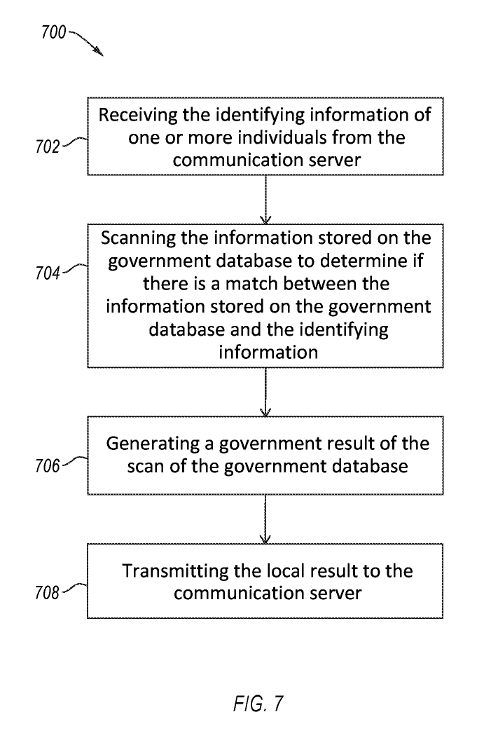

FIG. 7 is a flow chart of a method 700 to screen one or more individuals using the system 100 of FIG. 1, according to an embodiment, from the perspective of the government database 114. In an embodiment, some of the acts of method 700 can be split into a plurality of acts, some of the acts can be combined into a single act, and some acts can be omitted. Also, it is understood that additional acts can be added to the method 700. Except as otherwise disclosed herein, the acts of method 700 can be used with any of the systems disclosed herein.

Act 702 of the method 700 includes “receiving identifying information of one or more individuals from the communication server 104” at the government database 114.

Act 704 of the method 700 includes “scanning the information stored on the government database 114 to determine if there is a match between the information stored on the government database 114 and the identifying information.” Act 706 of the method 700 includes “generating a government result of the scan of the government database 114.” In an embodiment, the government database 114 did not find any matches between the identifying information and the information stored thereon during act 704. In such an embodiment, the government result generated during act 706 can include a message indicating that no matches were found. In an embodiment, the government database 114 found at least one match between the identifying information and the information stored thereon during act 704. In such an embodiment, the government result can include the matching information, any information stored on the government database 114 associated with the matching information, or any other additional information, such as confidential information.

Act 708 of the method 700 includes “transmitting the government result to the communication server 104.”

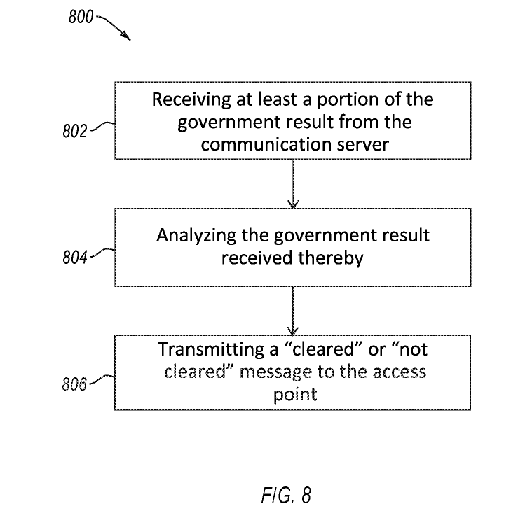

FIG. 8 is a flow chart of a method 800 to screen one or more individuals using the system 100 of FIG. 1, according to an embodiment, from the perspective of the law enforcement agency 116. In an embodiment, some of the acts of method 800 can be split into a plurality of acts, some of the acts can be combined into a single act, and some acts can be omitted. Also, it is understood that additional acts can be added to the method 800. Except as otherwise disclosed herein, the acts of method 800 can be used with any of the systems disclosed herein.

Act 802 of the method 800 includes “receiving at least a portion of the government result from the communication server 104.” For example, act 802 can include receiving the government result at a computer, mobile device, etc. that is under the control of the law enforcement agency.

Act 804 of the method 800 includes “analyzing the government result.” In an example, act 804 can include a law enforcement officer analyzing the government result. In an example, act 802 can include the law enforcement agency 116 comparing the information contained in the government result against the entrance criteria.

Act 806 of the method 800 includes “transmitting a ‘cleared’ or ‘not cleared’ message to the access point 102.” For example, act 806 can include transmitting the “cleared” or “not cleared message” directly to the access point 102 or indirectly to the access point 102 via the communication server 102. Act 802 can also include transmitting a “reviewed” message with the “cleared” or “not cleared” message.

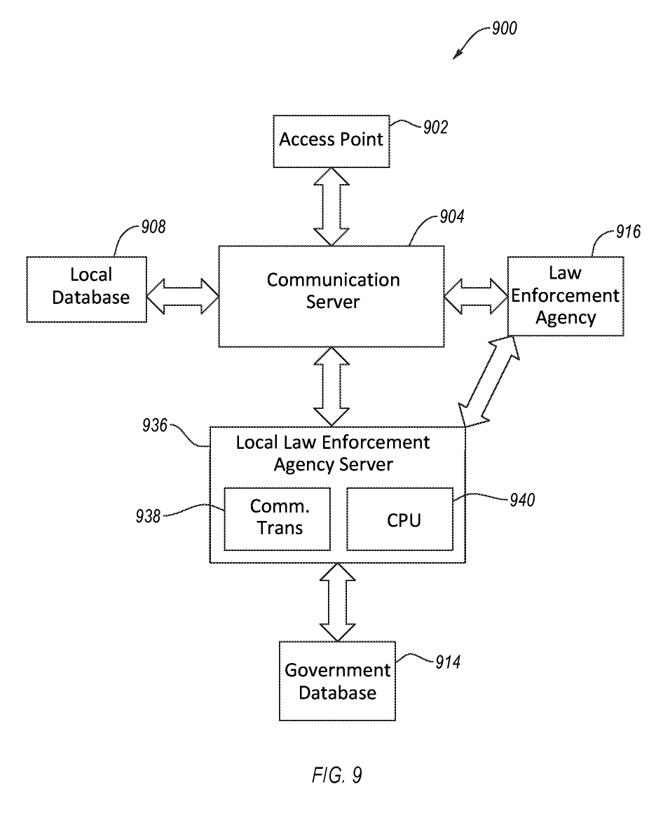

FIG. 9 is a schematic view of a system 900 that is used to screen one or more individuals, according to an embodiment. Except as otherwise disclosed herein, the system 900 can be the same as or substantially similar to the system 100 of FIG. 1. For example, the system 900 can include an access point 902, a communication server 904, a local database 908, a government database 914, and a law enforcement agency 916.

In an embodiment, a sponsor may require that a component of the system 900 that communicates with the government database 914 to be physical located on the sponsor's property. However, it can be at least one of difficult, inefficient, or inconvenient to locate the communication server 904 on the sponsor's property. For example, the sponsor's property may be located at a distance from a company to owns and/or manages the communication server 904 thereby increasing the burden on the company. For example, the communication server 904 can operate with a plurality of sponsors. In such an example, at least some of the sponsors may require that the component of the system 900 that communicates with the government database 914 be located on the sponsor's property. This would require multiple communication servers 904 to be used when only one communication server 904 is needed thereby increasing the cost and complexity of the system 900 and creating redundancies. To remedy these problems, in an embodiment, the system 900 can include at least one local law enforcement agency server 936. The local law enforcement agency server 936 can be located on a sponsor's property (e.g., in a law enforcement office or precinct) and can communicably couple the communication server 904 with the government database 914. This allows the system 900 to include a single communication server 904 at a central location that operates in connection with a plurality of different sponsors regardless of the requirements of each sponsor.

The local law enforcement agency server 936 includes a communication transceiver 938 that communicably couples the local law enforcement agency server 936 to the communication server 904 and the government database 914. The communication transceiver 938 can also communicably couple to the local law enforcement agency server 936 to the law enforcement agency 916. The local law enforcement agency server 936 also includes a CPU 940 that can be the same or similar to the CPU 132 of FIG. 1. For example, CPU 940 can verify the identity of communication server 904 and/or that the communication server 904 is authorized to make the request, as previously described herein. Similar to the communication server 104 of FIG. 1, the local law enforcement agency server 936 is not under law enforcement only control and is instead at least partially under third party control.

In an embodiment, the local law enforcement agency server 936 merely acts as a communication pass through between the communication server 904 and the government database 914. For example, the local law enforcement agency server 936 can receive a request to search the government database 914 from the communication server 904, transmit the result to the government database 914, receive the government result from the government database 914, and transmit the government result to the communication server 904. In an example, the local law enforcement agency server 936 can verify the identity of communication server 904 and/or that the communication server 904 is authorized to make the request, as previously described herein.

In an embodiment, the local law enforcement agency server 936 does not parse the government results received thereby and, instead, merely transmits the government result to the communication server 904. In an embodiment, the local law enforcement agency server 936 can be configured to parse the government result received thereby. Parsing the government result with the local law enforcement agency server 936 can prevent the dissemination of at least some of the confidential information in the government result outside of the law enforcement controlled property. In an example, the local law enforcement agency server 936 can parse the government result to remove at least some of the confidential or extraneous information therefrom before transmitting the government result to the communication server 904. In an example, the local law enforcement agency 936 can analyze the government result to determine if the information contained in the government result triggers at least one of the one or more entrance criteria.

In an embodiment, the local law enforcement agency server 936 analyzes the government result and determines that the information contained in the government result does not trigger any entrance criteria. In such an embodiment, the local law enforcement agency server 936 can transmit a “cleared” message to the communication server 904. The local law enforcement agency server 936 can also transmit one or more additional portions of the government result to the communication server 904, such as the entire government result, the government result with any confidential information removed therefrom, etc. In another embodiment, the local law enforcement agency server 936 analyzes the government result and determines that the information contained in the government result does trigger at least one entrance criteria. In such an embodiment, the local law enforcement agency server 936 can transmit a “not cleared” message to the communication server 904, thereby leaving it up to the communication server 904 to determine whether or not the law enforcement agency 916 is informed. The local law enforcement agency server 936 can also transmit one or more additional portions of the government result to the communication server 904. In another embodiment, the local law enforcement agency server 936 analyzes the government result and determines that the information contained in the government result does trigger at least one entrance criteria. In such an embodiment, the local law enforcement agency server 936 can transmit at least a portion of the government result to the law enforcement agency 916. The local law enforcement agency server 936 can transmit a “pending” message to the communication server 904 thereby notifying that the government result was transmitted to the law enforcement agency 916 and that further communication will come from the law enforcement agency 916.

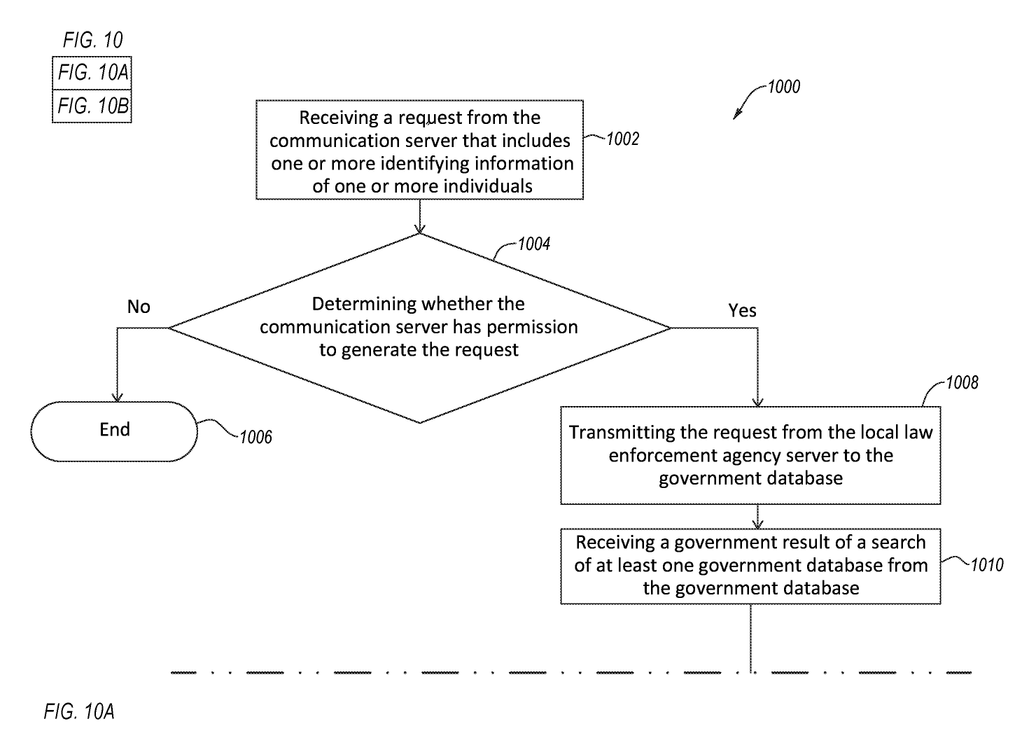

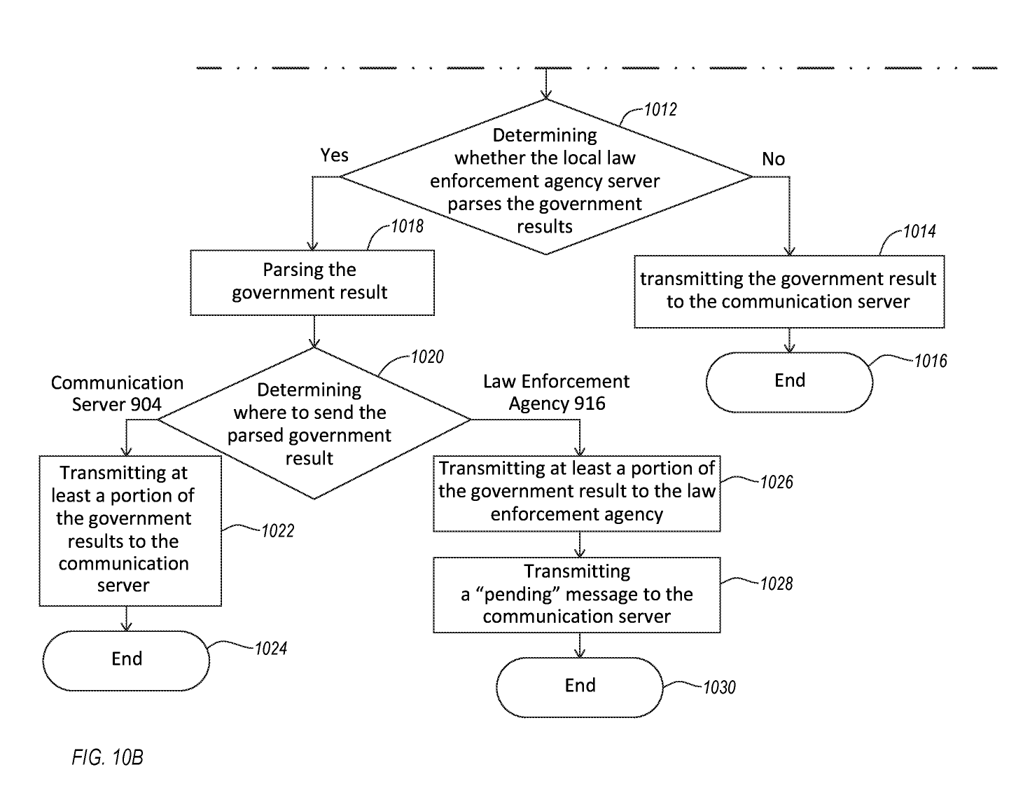

FIG. 10 is a flow chart of a method 1000 to screen one or more individuals using the system 900 of FIG. 9, according to an embodiment, from the perspective of the local law enforcement agency server 936. For ease of illustration, FIG. 10 has been split into FIGS. 10A and 10B. In an embodiment, some of the acts of method 1000 can be split into a plurality of acts, some of the acts can be combined into a single act, and some acts can be omitted. Also, it is understood that additional acts can be added to the method 1000. Except as otherwise disclosed herein, the acts of method 1000 can be used with any of the systems disclosed herein.

Act 1002 of the method 1000 includes “receiving a request from the communication server 904 that includes one or more identifying information of one or more individuals.” In an example, the request received by the local law enforcement agency server 936 can conform to the requirements of the government database 914. In such an example, the local law enforcement agency server 936 merely needs to forward the request to the government database 914 with no or minimal editing of the request. In another example, the request received by the local law enforcement agency server 936 does not conform to the requirements of the government database 914. In such an example, the local law enforcement agency server 936 can format the request to conform to the requirements of the government database 914. Act 1002 can be performed by at least the communication transceiver 938 of the local law enforcement agency server 936.

Act 1004 of the method 1000 includes “determining whether the communication server 904 has permission to generate the request.” In an embodiment, act 1004 can include verifying the identity of the communication server 904 and that the communication server 904 has permission to request the search of the government database 914. Act 1004 can be performed on the CPU 940 of the local law enforcement agency server 936.

In an embodiment, the local law enforcement agency server 936 can determine that the communication server 904 does not have permission to generate the request. In such an embodiment, the method 1000 includes act 1006, which includes “transmitting a message to the communication server 904 stating that the communication server 904 does not have permission to generate the first request.” Act 1006 effectively terminates the method 1000. In an embodiment, the local law enforcement agency server 936 can determine that the communication server 904 does have permission to generate the request. In such an embodiment, the method 1000 can continue onto act 1008. Act 1006 can be performed using the second communication transceiver 130.

In an embodiment, the local law enforcement agency server 936 can determine that the communication server 904 does have permission to generate the request. In such an embodiment, the method 1000 can continue onto act 1008, which includes “transmitting the request from the local law enforcement agency server 936 to the government database 914.” Act 1010 of the method 1000 includes “receiving a government result of a search of at least one government database 914 from the government database 914.” Act 1008 and 1010 can be performed by the communication transceiver 938.

Act 1012 of the method 1000 includes “determining whether the local law enforcement agency server 936 parses the government results.” In an example, act 1012 includes examining the permissions granted to the communication server 904 and determining whether the permissions permit the distribution of the government result to the communication server 904. In an example, act 1012 can be omitted (e.g., the local law enforcement agency server 936 is configured to always or never parse the government result). Act 1012 can be performed by the CPU of the local law enforcement agency server 936.

In an embodiment, act 1012 includes determining that the local law enforcement agency server 936 does not parse the government results. In such an embodiment, the method 1000 includes act 1014, which includes “transmitting the government result to the communication server 904” followed by terminating the method at act 1016. Act 1014 can be performed by the communication server.

In an embodiment, act 1012 includes determining that the local law enforcement agency server 936 does parse the government result. In such an embodiment, the method 1000 includes act 1018, which includes “parsing the government result.” In an example, act 1018 includes parsing the government result to remove confidential information (e.g., information that the communication server 904 is not permitted to receive) or extraneous information from the government results. In an example, act 1018 includes analyzing the information to determine if the information of the government results triggers at least one of the one or more entrance criteria. Act 1018 can be performed by the CPU 940 of the local law enforcement agency server 936.

Act 1020 of the method 1000 includes “determining where to send the parsed government result?” Act 1020 can be performed by the CPU 940 of the local law enforcement agency server 936.

In an embodiment, act 1020 includes determining that at least a portion of the government results is to be sent to the communication server 904, such as when the government result constitutes a nondisqualifying match. In such an embodiment, the method 1000 includes act 1022, which includes “transmitting at least a portion of the government results to the communication server 904.” In an example, act 1020 includes transmitting a portion of the government response that does not include confidential or extraneous information. In an example, act 1022 includes transmitting at least the result of the local law enforcement agency server's 936 analysis of the government result (e.g., a “cleared” message) and, optionally, other portions of the government result (e.g., all of the government result). After act 1022, the method 1000 includes terminating the method at act 1024.

In an embodiment, act 1020 includes determining that at least a portion of the government results is to be sent the law enforcement agency 916, such as when the government result constitutes a potential disqualifying match. In such an embodiment, the method 1000 includes act 1026, which includes “transmitting at least a portion of the government result to the law enforcement agency 916.” Additionally, the method 1000 can include act 1028, which includes “transmitting a ‘pending’ message to the communication server 904.” After acts 1026 and 1028, the method 1000 can terminate at act 1030

Methods of using the access point 902 is the same as or similar to the methods of using the access point 102 as previously discussed herein (see methods 200 and 300 of FIGS. 2 and 3). The methods of using the local database 908 is the same as or similar to the methods of using the local database 108 as previously discussed herein (see method 600 of FIG. 6). The methods of using the communication server 904 is the same as or similar to the methods of using the communication server 104 as previously discussed herein (see methods 300 and 400 of FIGS. 4 and 5), except that the communication server 904 communicates with the government database 914 through the local law enforcement agency server 936 and/or the local law enforcement agency server 936 parses the information instead of or in conjunction with the communication server 904. The methods of using the government database 914 is the same as or similar to the methods of using the government database 114 as previously discussed herein (see method 700 of FIG. 7), except that the government database 914 communicates directly with the local law enforcement agency server 936 instead of the communication server 904. The method of using the law enforcement agency 916 is the same as or similar to the methods of using the law enforcement agency 116 as previously discussed herein (see method 800 of FIG. 8), except that the law enforcement agency 916 can receive the information from the local law enforcement agency server 936 instead of the communication server 904.

While various aspects and embodiments have been disclosed herein, other aspects and embodiments are contemplated. The various aspects and embodiments disclosed herein are for purposes of illustration and are not intended to be limiting.

What is claimed is:

1. A method to screen one or more individuals at a non-law enforcement facility, the method comprising:
generating a first request at an access point, the first request including one or more identifying information for the one or more individuals, the access point located at and/or near the non-law enforcement facility, the access point including memory storage medium including one or more instructions stored therein, at least one processor configured to execute the one or more instructions, one or more input devices configured to receive the one or more identifying information, a display, and a first communication transceiver coupled to the processor;
with the first communication transceiver, transmitting the first request to at least one communication server that is not under law enforcement only control; and
with the first communication transceiver, receiving at least a portion of a local result of a search of at least one local database that is not under law enforcement only control.

2. The method of claim 1, further comprising, with the first communication transceiver, transmitting the one or more identifying information of the one or more individuals directly to the at least one local database.

3. The method of claim 1, wherein receiving at least a portion of the local result includes receiving a “cleared” or “not cleared” message from the communication server.

4. The method of claim 1, wherein the at least a portion of the local result received by the access point includes: identifying information stored on the at least one local database that at least partially matched the one or more identifying information of the one or more individuals and/or information associated with the identifying information stored on the at least one local database; and
further comprising, with the at least one processor of the access point, parsing the information associated with the identifying information stored on the at least one local database to determine if the information associated with the identifying information stored on the at least one local database is associated with one or more entrance criterias, the one or more entrance criterias including one or more preselected criteria that is used to screen the one or more individuals.

5. The method of claim 1, further comprising, responsive to receiving the at least a portion of the local result, displaying at least a “cleared” or “not cleared” message using the display.

6. The method of claim 1, further comprising, after receiving the at least a portion of the local result, transmitting a second request to search at least one government database to the communication server with the first communication transceiver, the second request including the one or more identifying information of the one or more individuals.

7. The method of claim 6, further comprising receiving at least a portion of a government result of the search of the at least one government database from the communication server.

8. The method of claim 7, wherein receiving at least a portion of the government result includes receiving a “cleared” or “not cleared” message from the communication server.

9. The method of claim 7, wherein the at least a portion of the government result received by the access point includes: identifying information stored on the at least one government database that at least partially matched the one or more identifying information of the one or more individuals and information associated with the identifying information stored on the at least one government database; and
further comprising, with the at least one processor of the access point, parsing the information associated with the identifying information stored on the at least one government database to determine if the information associated with the identifying information stored on the at least one government database is associated with one or more entrance criterias, the one or more entrance criterias including one or more preselected criteria that is used to screen the one or more individuals.

10. The method of claim 7, further comprising, responsive to receiving the at least a portion of the government result, displaying at least a “cleared,” “not cleared,” or “pending” message using the display.

11. A method to screen one or more individuals at a non-law enforcement facility, the method comprising:
receiving a first request from an access point at a communication server that is not under law enforcement-only control, the first request including one or more identifying information of the one or more individuals, the communication server including a central processing unit and a second communication transceiver, wherein the second communication transceiver is communicably coupled to the access point; and
with the second communication transceiver, transmitting at least the one or more identifying information of the one or more individuals to at least one government database; and
with the second communication transceiver, receiving a government result of a search of the at least one government database, the government result including:
identifying information stored on the at least one government database that at least partially matched the one or more identifying information of the one or more individuals; and
information associated with the identifying information stored on the at least one government database.

12. The method of claim 11, wherein transmitting at least the one or more identifying information of the one or more individuals to at least one government database comprises transmitting at least the one or more identifying information to a local law enforcement agency server.

13. The method of claim 11, further comprising, after receiving the government result, with the second communication transceiver, transmitting at least a portion of the government result to the access point.

14. The method of claim 11, further comprising, after receiving the government result, with the central processing unit, parsing the information associated with the identifying information stored on the at least one government database to determine if the information associated with the identifying information stored on the at least one government database is associated with one or more entrance criteria, the one or more entrance criteria including one or more preselected criteria that is used to screen the one or more individuals.

15. The method of claim 14, further comprising, after parsing the information associated with the identifying information stored on the at least one government database, with the second communication transceiver, transmitting at least a “cleared” or “not cleared” message to the access point.

16. The method of claim 11, further comprising, with the second communication device, transmitting at least some of the at least a portion of the government result received by the communication server to at least one of an law enforcement agency wherein the law enforcement agency is authorized to view the at least some of the at least a portion of the government result.

17. The method of claim 11, further comprising, with the second communication transceiver, transmitting a “pending” message to the access point.

18. The method of claim 11, further comprising, after receiving the first request from the access point, transmitting at least the one or more identifying information of the one or more individuals to at least one local database, the communication server communicably coupled to the at least one local database.

19. The method of claim 18, further comprising, after transmitting at least the one or more identifying information of the one or more individuals to the at least one local database, with the second communication device, receiving from the local database a local result of a search of the at least one local database.

20. The method of claim 19, further comprising, with the second communication device, transmitting at least a portion of the local result received by the communication server to the access point.

21. A system to screen one or more individuals from a non-law enforcement facility, the system comprising:
an access point at and/or near the non-law enforcement facility, the access point including memory storage medium including one or more instructions stored therein, at least one processor configured to execute the one or more instructions, one or more input devices configured to receive the one or more identifying information, a display, and a first communication transceiver coupled to the processor;
a communication server that is not under law enforcement only control, the communication server including a central processing unit and a second communication transceiver coupled to the first communication transceiver; and
at least one local database operably coupled to at least one of the access point and/or the communication server, the at least one local database stored on memory storage medium of a general purpose or special purpose computer, the at least one local database configured to be searched to find matches between the plurality of government results stored thereon and the one or more identifying information received by the at least one local database, wherein each of the government results includes:
identifying information used to generate the government result; and
information associated with the identifying information used to generate the government result that was found during a previous search of at least one government database.

21. The system of claim 21, further comprising a government controlled domain, the government controlled domain including at least one government database operably coupled to the second server.

22. The system of claim 21, further comprising a local law enforcement agency servers operably coupled to at least the communication server.
